(19) United States
(12) Patent Application Publication
(10) Pub. No.: US 2024/0401713 A1
(43) Pub. Date: Dec. 5, 2024

(54) Serviceable Pressure Regulator

(71) Applicant: Rain Bird Corporation, Azusa, CA (US)

(72) Inventor: Craig David Carroll, Costa Mesa, CA (US)

(21) Appl. No.: 18/205,428

(22) Filed: Jun. 2, 2023

(51) Int. Cl. F16K 27/02; F16K 17/04

(52) U.S. Cl. CPC F16K 27/0209; F16K 17/04

(57) ABSTRACT

A pressure regulator with a serviceable lock is provided. The pressure regulator with a serviceable lock including a housing body having an inlet and an outlet with an internal cavity disposed therebetween. The housing body including an upper housing and a lower housing that are removably couplable to one another so that the housing body can be moved between an open position and a closed position. The first housing having a latch that is configured to engage with a channel on the second housing to prevent the rotation of the first housing relative to the second housing when the housing body is in the closed position. The internal cavity of the housing body configured to receive a pressure regulator assembly that forms a watertight seal between the upper housing and the lower housing when the housing body is in the closed position.

### FIELD

This disclosure relates to pressure regulation devices and methods and, more particularly, to serviceable pressure regulation devices and methods.

### BACKGROUND

Irrigation systems benefit from servicing to maintain it operating at an optimal performance. Irrigation equipment in an irrigation system can suffer performance degradation due to component wear, poor water quality, or debris build up. Irrigation equipment commonly includes pressure regulators and/or check valves. Pressure regulators are responsible for controlling the water pressure that flows from a water source, such as a well or municipal water supply, to the irrigation system. When the water pressure is too high for the irrigation system, irrigation discharge devices (e.g., sprinklers) will not properly discharge the required water for irrigation. Check valves are used to prevent water from an irrigation system from draining through irrigation discharge devices. These maintain the irrigation system primed with water and prevent water waste.

One known shortcoming with current pressure regulators and check valves is the inability to easily service them. For instance, the housing for such devices is commonly secured with screws and/or is welded shut such that access to the internal components is difficult (e.g., requires tools or is not possible at all). Thus, when a pressure regulator or check valve under-performs, it is common practice to replace the entire unit with a new one. Having to replace the entire unit can be a waste when only a few components need to be either replaced or simply cleaned. This option would be more cost and environment friendly. Therefore, pressure regulators and check valves with a housing that can be easily opened without tools to provide access to the internal components is desired.

### BRIEF DESCRIPTION OF THE DRAWINGS

FIG. 1 is a side elevation view of one embodiment of a pressure regulator with a serviceable lock according to one aspect of the present disclosure;

FIG. 2 is an exploded view of the pressure regulator of FIG. 1;

FIG. 3 is another exploded view of the pressure regulator of FIG. 1;

FIG. 4 is a cross-section of the pressure regulator of FIG. 1 along cross-sectional line A as illustrated in FIG. 1;

FIG. 5 is an elevation view of an upper housing separated from a lower housing of the pressure regulator of FIG. 1;

FIG. 6 is a perspective view of the upper housing separated from the lower housing of the pressure regulator of FIG. 1;

FIG. 7 is an exploded view of the upper housing and a pivot latch of the pressure regulator of FIG. 1;

FIG. 8 is an exploded view of the upper housing and the pivot latch of the upper housing of the pressure regulator of FIG. 1;

FIG. 9 is an exploded top view of the upper housing and the pivot latch of the upper housing of the pressure regulator of FIG. 1;

FIG. 10 is an exploded bottom view of the upper housing and the pivot latch of the upper housing of the pressure regulator of FIG. 1;

FIG. 11 is a perspective view of the lower housing of the pressure regulator of FIG. 1;

FIG. 12 is perspective view of the lower housing of the pressure regulator of FIG. 1;

FIG. 13 is a top view of the lower housing of the pressure regulator of FIG. 1;

FIG. 14 is a bottom view of the lower housing of the pressure regulator of FIG. 1;

FIG. 15 is a side perspective view of another embodiment of a pressure regulator with a serviceable lock according to one aspect of the present disclosure;

FIG. 16 is an exploded view of the pressure regulator of FIG. 15;

FIG. 17 is an exploded view of the pressure regulator of FIG. 15

FIG. 18 is a cross-section view of the pressure regulator of FIG. 15 along cross-sectional line B as illustrated in FIG. 15;

FIG. 19 is a side-view of an upper housing separated from a lower housing of the pressure regulator of FIG. 15;

FIG. 20 is a perspective view of the upper housing separated from the lower housing of the pressure regulator of FIG. 15;

FIG. 21 is an exploded view of the upper housing and a pivot latch of the upper housing of the pressure regulator of FIG. 15;

FIG. 22 is an exploded view of the upper housing and the pivot latch of the upper housing of the pressure regulator of FIG. 15;

FIG. 23 is an exploded top view of the upper housing and the pivot latch of the upper housing of the pressure regulator of FIG. 15;

FIG. 24 is an exploded bottom view of the upper housing and the pivot latch of the upper housing of the pressure regulator of FIG. 15;

FIG. 25 is a perspective view of the lower housing of the pressure regulator of FIG. 15;

FIG. 26 is another perspective view of the lower housing of the pressure regulator of FIG. 15;

FIG. 27 is a top view of the lower housing of the pressure regulator of FIG. 15;

FIG. 28 is a bottom view of the lower housing of the pressure regulator of FIG. 15;

FIG. 29 is a side perspective view of another embodiment of a pressure regulator with a serviceable lock according to one aspect of the present disclosure;

FIG. 30 is an exploded view of the pressure regulator of FIG. 29;

FIG. 31 is an exploded view of the pressure regulator of FIG. 29;

FIG. 32 is a cross-section of the pressure regulator of FIG. 29 along cross-sectional line C as illustrated in FIG. 29;

FIG. 33 is an elevational view of an upper housing separated from a lower housing of the pressure regulator of FIG. 29;

FIG. 34 is a perspective view of the upper housing separated from the lower housing of the pressure regulator FIG. 29;

FIG. 35 is an exploded view of the upper housing and the slide latch of the upper housing of the pressure regulator of FIG. 29;

FIG. 36 is an exploded view of the upper housing and the slide latch of the upper housing of the pressure regulator of FIG. 29;

FIG. 37 is an exploded top view of the upper housing and the slide latch of the upper housing of the pressure regulator of FIG. 29;

FIG. 38 is an exploded bottom view of the upper housing and the slide latch of the upper housing of the pressure regulator of FIG. 29;

FIG. 39 is a perspective view of the lower housing of the pressure regulator of FIG. 29;

FIG. 40 is another perspective view of the lower housing of the pressure regulator of FIG. 29;

FIG. 41 is a top view of the lower housing of the pressure regulator of FIG. 29;

FIG. 42 is a bottom view of the lower housing of the pressure regulator of FIG. 29;

FIG. 43 is a side perspective view of another embodiment of a pressure regulator with a serviceable lock according to one aspect of the present disclosure;

FIG. 44 is an exploded view of the pressure regulator of FIG. 43;

FIG. 45 is an exploded view of the pressure regulator of FIG. 43;

FIG. 46 is a cross-section of the pressure regulator of FIG. 43 along cross-sectional line D as illustrated in FIG. 43;

FIG. 47 is an elevational view of a upper housing separated form a lower housing of the pressure regulator of FIG. 43;

FIG. 48 is a perspective view of the upper housing separated from the lower housing of the pressure regulator of FIG. 43;

FIG. 49 is an exploded view of the upper housing and a slide latch of the upper housing of the pressure regulator of FIG. 43;

FIG. 50 is an exploded view of the upper housing and the slide latch of the upper housing of the pressure regulator of FIG. 43;

FIG. 51 is an exploded top view of the upper housing and the slide latch of the upper housing of the pressure regulator of FIG. 43;

FIG. 52 is another exploded bottom view of the upper housing and the slide latch of the upper housing of the pressure regulator of FIG. 43;

FIG. 53 is a perspective view of the lower housing of the pressure regulator of FIG. 43;

FIG. 54 is a perspective view of the lower housing of the pressure regulator of FIG. 43;

FIG. 55 is a top view of the lower housing of the pressure regulator of FIG. 43;

FIG. 56 is a bottom view of the lower housing of the pressure regulator of FIG. 43;

FIG. 57 is an exploded view of one embodiment of a pressure regulator flow tube assembly according to one aspect of the present disclosure that can be used with any of the embodiments of the pressure regulator with a serviceable lock as illustrated in FIGS. 1-14, FIGS. 15-28, FIGS. 29-42, and FIGS. 43-56 and discussed herein.

### DETAILED DESCRIPTION

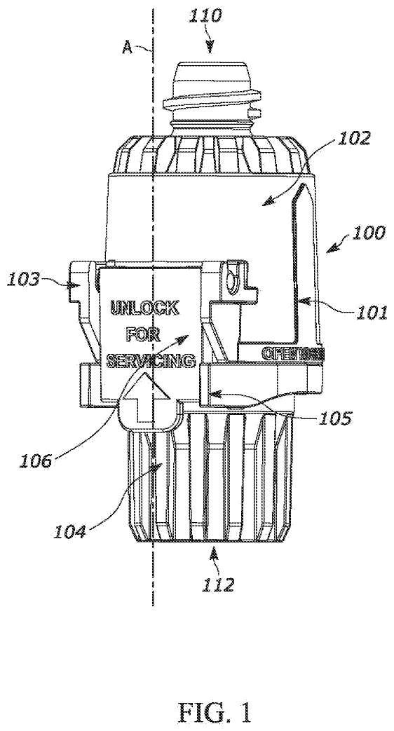

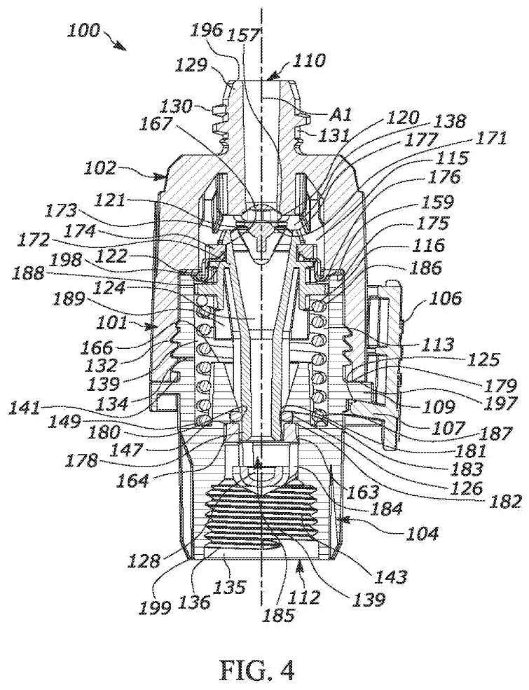

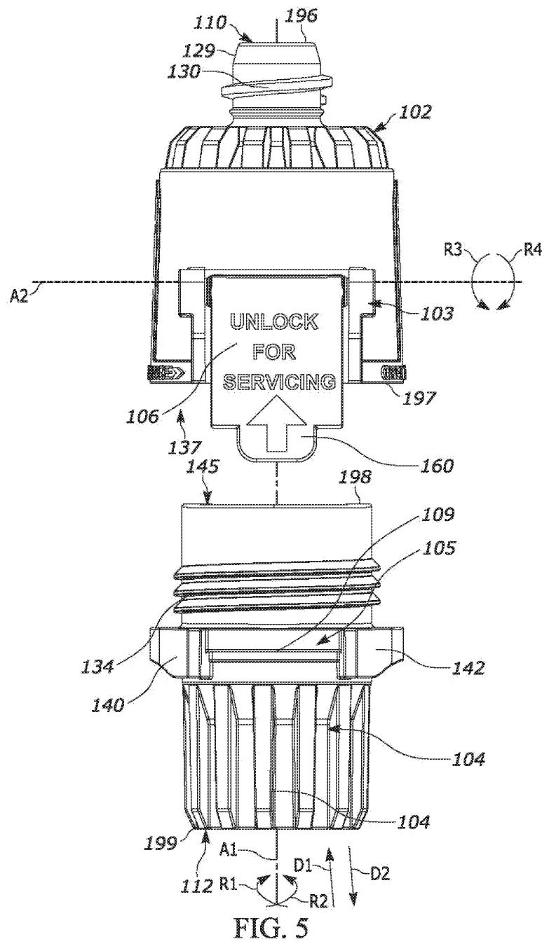

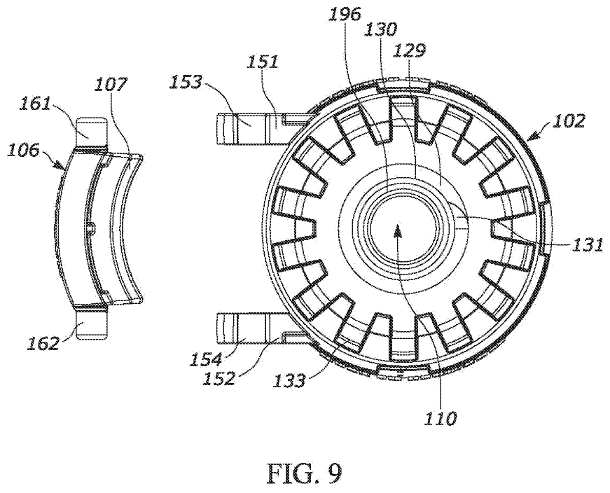

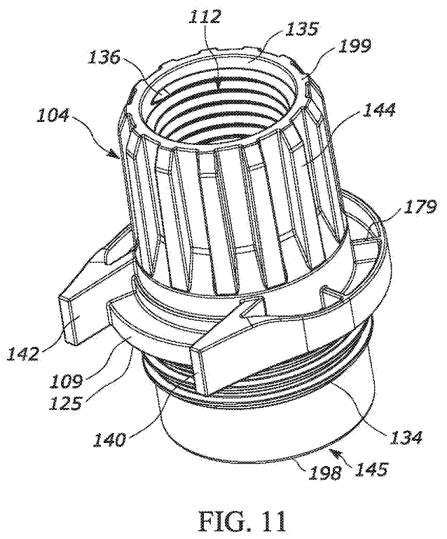

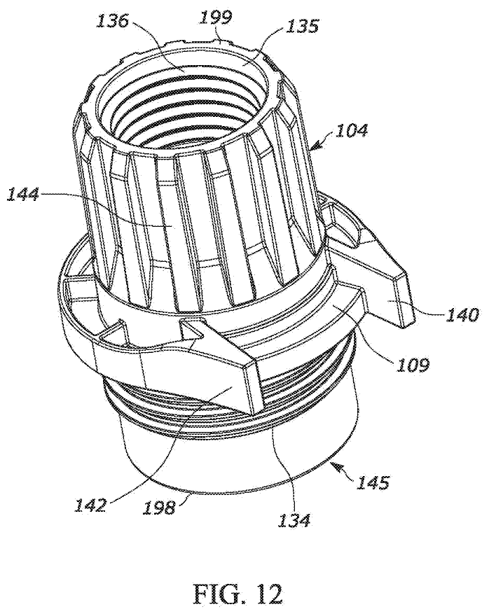

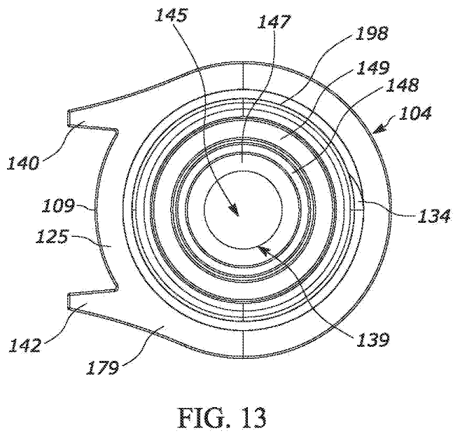

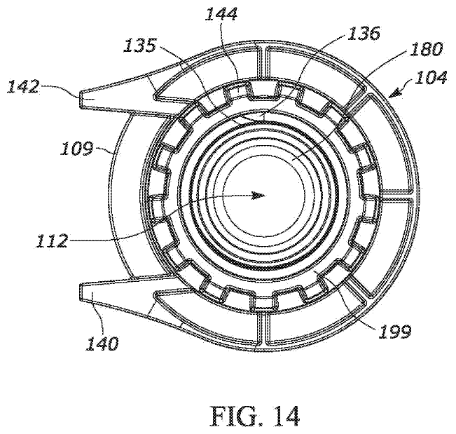

FIGS. 1-14 illustrate one embodiment of a pressure regulator with a serviceable lock 100 (hereinafter referred to as pressure regulator 100). The pressure regulator 100 includes a housing body 101 with a water outlet 110 and a water inlet 112 separated by an internal cavity 113 (FIG. 4). The housing body 101 has a first or upper or outflow housing 102 and a second or lower or inflow housing 104. The housings 102, 104 are separable from one another, such that the pressure regulator 100 has a first or open or disassembled position (FIG. 5) where the upper housing 102 is not coupled with the lower housing 104 and a second or closed or assembled position (FIG. 1) where the upper housing 102 is coupled to the lower housing 104.

The upper housing 102 includes a first or top end 196 and a second or bottom end 197 with an internal cavity 138 disposed therebetween. The top end 196 of the upper housing 102 includes the water outlet 110 disposed at a terminal end of a male coupling 129 An opposite end defines an opening 137 to the internal cavity 138 of the upper housing 102. The male coupling member 129 includes a male thread 130 disposed about an exterior surface 131 of the male coupling member 129. The male coupling member 129 configured to couple to a corresponding female coupling member with a corresponding female thread such as one on another component of an irrigation system. For example, it could be a corresponding female coupling member on an irrigation hose. The male coupling member 129 is rotationally coupled with the female coupling of the other component of an irrigation system by, for example, rotating the upper housing 102 in direction R2 about axis of rotation A1 until the male thread 130 forms a watertight seal with the female thread of the corresponding female coupling member.

The lower housing 104 has a first or top end 198 and an opposite second or bottom end 199 with an internal cavity 139 formed therebetween. The top end 198 of the lower housing 104 defines an opening 145 into the internal cavity 139 of the lower housing 104. The bottom end 199 of the lower housing 104 includes the water inlet 112 proximate to a female coupling 135 that extends into the internal cavity 139 of the lower housing 104. The female coupling 135 removably couples to a water source (not shown), such as, but not limited to, male end of an irrigation hose. The female coupling 135 includes a female thread 136 disposed about an internal surface 143 of the female coupling 135. The female coupling 135 can be removably and rotationally coupled with the male coupling of the water providing source by rotating the lower housing 104 in direction R1 about axis of rotation A1 until a male thread of the male coupling engages with and forms a watertight seal with the female thread 136 of the female coupling 135.

The upper housing 102 includes a female thread 132 disposed about the internal cavity 138 at the opening 137, and the lower housing 104 includes a corresponding male thread 134 disposed about an exterior surface 141. The male thread 134 configured to mate with the female thread 132 when an upper end 198 of the lower housing 104 is inserted into the opening 137 of the upper housing 102 so at least a portion of the upper end 198 of the lower housing 104 extends into the internal cavity 138 of the upper housing 102. The female thread 132 and the male thread 134 rotationally couple the lower end 197 of the upper housing 102 with the upper end 198 of the lower housing 104, such that a watertight seal is formed between the upper housing 102 and the lower housing 104.

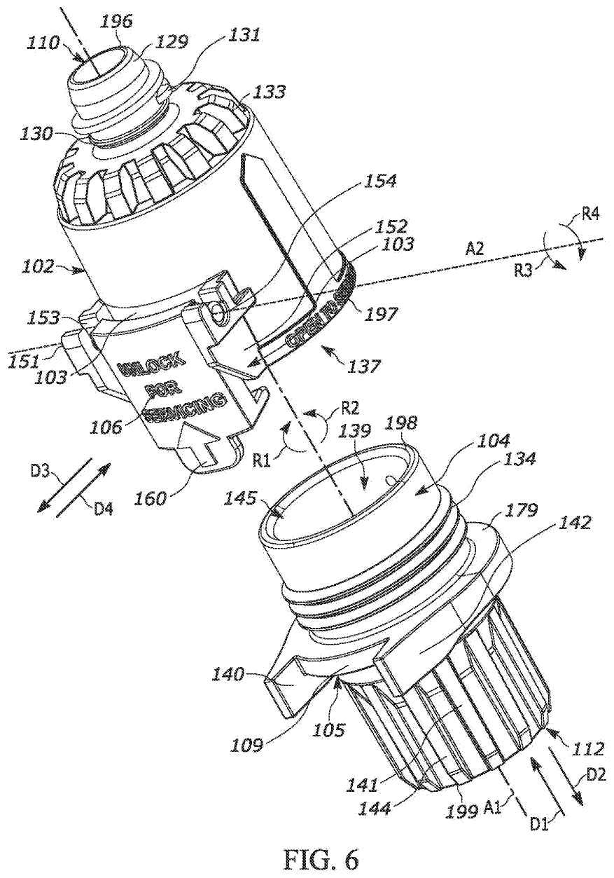

The upper housing 102 includes radially extending ridges 133 (FIG. 6) disposed about its exterior surface that enhance gripping for a user rotating the upper housing 102 about axis A1. Likewise, the lower housing 104 also includes radially extending ridges 144 (FIG. 6) disposed about its exterior surface to enhance gripping for a user when rotating the upper housing 104 about axis A1.

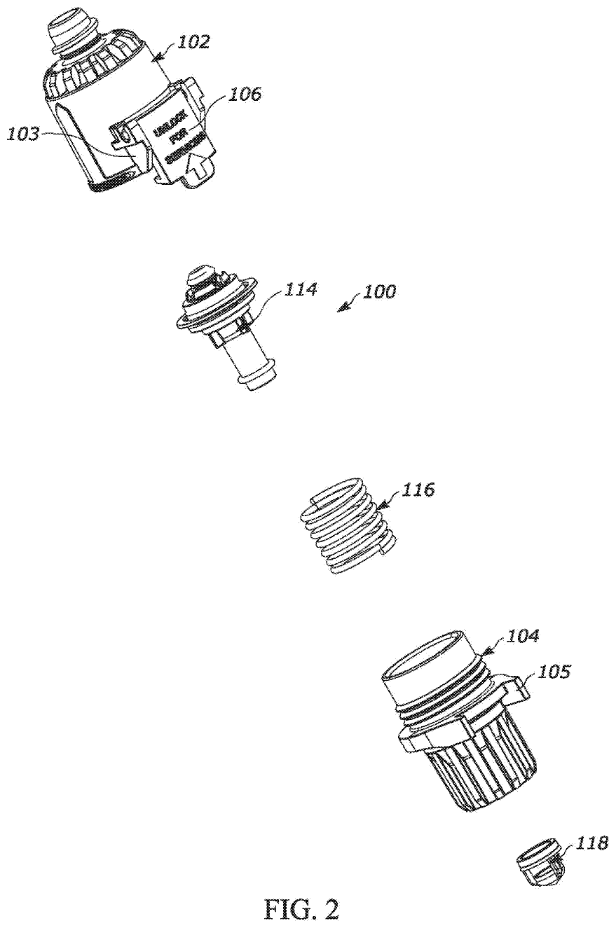

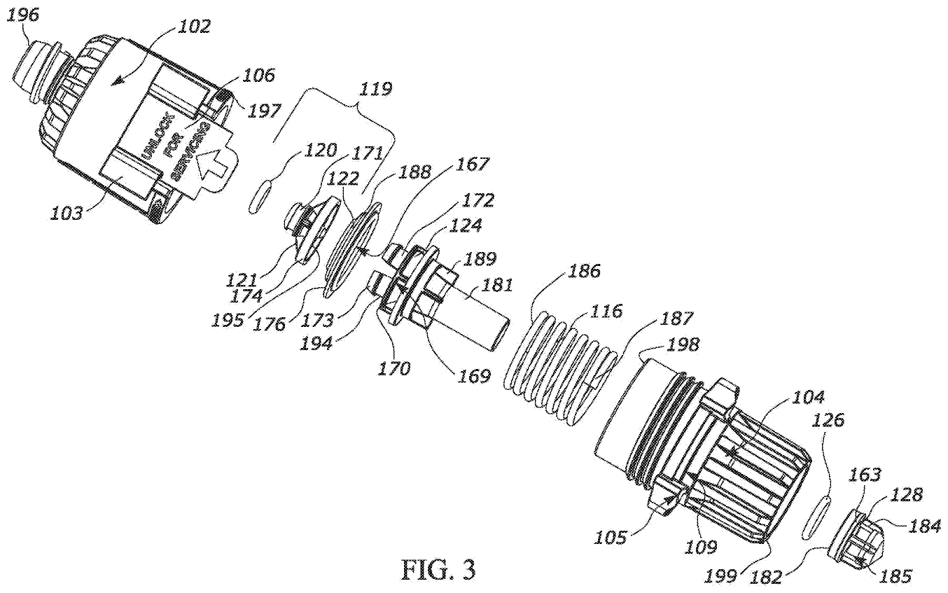

Turning to FIGS. 2 and 3, the interworking components of the pressure regulator 100 are illustrated. The components are easily removed from the housing body 101 and can be disassembled and reassembled for maintenance (e.g., cleaning) and replacement. More specifically, the pressure regulator includes a diaphragm pressure regulator with check valve flow tube assembly 114, a spring 116, and an inflow insert with O-ring press fit assembly 118. The diaphragm pressure regulator with check valve flow tube assembly 114 generally includes a rubber washer 120, a check valve 121, a diaphragm 122, and a flow tube 124. The rubber washer 120 removably seats in a groove 171 defined on the check valve 121. Prongs 172 located at a first or top end 177 of the flow tube 124 are inserted through an opening 167 defined by the diaphragm 122. The diaphragm 122 is positioned on the flow tube 124 so that an inner ring 188 of the diaphragm 122 is sandwiched between a top flange 194 of the flow tube 124 and the prongs 172 of the flow tube 124. Once the diaphragm 122 is properly positioned on the flow tube 124, the check valve 121 is coupled to the flow tube 124 by bringing the check valve 121 and the flow tube 124 together with sufficient force to move the prongs 172 and associated flanges 173 radially inward to pass the flanges 173 through corresponding openings 195 defined by a ring 174 of the check valve 121 and into engagement with the top of the ring 174 of the check valve 121.

Once the flanges 173 have passed through the ring 174, the prongs 172 will return to their natural position with the flanges 173 overlapped with a top side of the ring 174 to secure the flow tube 124 to the check valve 121. Securing the flow tube 124 to the check valve 121 retains the diaphragm 122 sandwiched between the ring 174 of the check valve 121 and the top flange 194 of the flow tube 124.

Once the diaphragm pressure regulator with check valve flow tube assembly 114 has been properly assembled, as illustrated in FIG. 2, the diaphragm pressure regulator with check valve flow tube assembly 114, spring 116, and inflow insert with O-Ring press fit assembly 118 can be aligned and inserted in the internal cavity 139 (see FIG. 6) of the lower housing 104. The second or lower end 187 of the spring 116 is inserted first into the opening 145 located at the top end 198 of the lower housing 104 and aligned so that the lower end 187 of the spring 116 seats against the ring 149 (FIG. 4) in the lower housing 104. The previously assembled diaphragm pressure regulator with check valve flow tube assembly 114 (FIG. 2) is then inserted into the opening 145 located at the top end 198 of the lower housing 104 with the second or bottom end 178 of the flow tube 124 being inserted first into the opening 145. The diaphragm pressure regulator with check valve flow tube assembly 114 is also aligned so that the bottom end 178 of the flow tube 124 is inserted within the interior of the previously installed spring 116.

As the diaphragm pressure regulator with check valve flow tube assembly 114 is inserted into the lower housing 104, the bottom end 178 of the flow tube 124 is also aligned with and received in a second ring 166 within the lower housing 104. The second ring 166 may have a conical or inwardly tapered shape to assist with insertion of the bottom end 178 of the flow tube 124 through the second ring 166 of the lower housing 104.

The bottom end 178 of the flow tube 124 is inserted through the second ring 166 until the flange 170 of the flow tube 124 abuts against the top end 186 of the spring 116 and the outer ring 176 of the diaphragm 122 is seated against the top end 198 of the lower housing 104.

After the diaphragm pressure regulator with check valve flow tube assembly 114 has been properly positioned within the lower housing 104, the inflow insert with O-Ring press fit assembly 118 including the O-Ring 126 and the inflow insert 128 will need to be coupled with the bottom end 178 of the flow tube 124 that should be at least partially extending through the second ring 166 of the lower housing 104.

The O-Ring 126 is inserted into the inlet opening 112 of the lower housing 104 and along the exterior surface 181 of the flow tube 124 until the O-Ring 126 seats between an annular corner 180 of the interior of the lower housing 104 and the exterior surface 181. Once properly positioned in the annular corner 180, the O-Ring 126 forms a watertight seal between the exterior surface 181 of the flow tube 124 and the interior surface of the lower housing 104.

The inflow insert 128 may be inserted along with (as a pusher for the O-Ring 126) or after the O-Ring 126 has been inserted into position. The inflow insert 128 is inserted into the water inlet 112 until the opening 182 of the inflow insert 128 receives the bottom end 178 of the flow tube 124. Upon insertion, the inflow insert 128 eventually contacts ring 147 provided in the lower housing 104. The inflow insert 127 will also engage a portion of the annular corner 180 to secure the O-Ring 126 in the annular corner 180. The inflow insert 128 includes an annular barb 163 that has a snap fit with an annular ledge 164 in the lower housing 128. The annular corner 180 and the annular ledge 164 captivate the flow insert 128.

As will be appreciated, the operation can be used to re-install the diaphragm pressure regulator with check valve flow tube assembly 114, the spring 116, or the inflow insert with O-ring press fit assembly 118 after any of them or their components have been repaired, replaced, or refurbished.

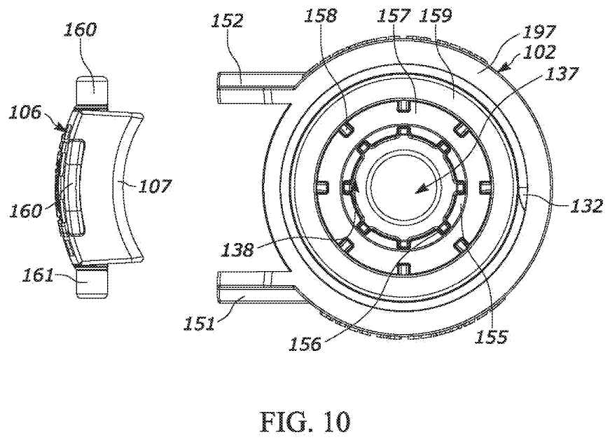

To couple the upper housing 102 and the lower housing 104 together, a user brings the two housings 102, 104 together. In one way, the lower housing 104 is moved in direction D1 (FIG. 5) so that the top end 198 of the lower housing 104 moves into the opening 137 and internal cavity 138 (FIG. 10) in the bottom end 197 of the upper housing 102 until the male threads 134 about the exterior surface 141 of the lower housing 104 engage the female threads 132 about the interior surface of the internal cavity 138 of the upper housing 102. Once engaged, the user will rotate the lower housing 104 in direction R2 about axis A1 until the outer ring 176 of the diaphragm 122, resting atop the upper end 198 of the lower housing 104, contacts the annular seat 159 facing upstream in the internal cavity 138 of the upper housing 102. As the user continues to turn the lower housing 104, the outer ring 176 of the diaphragm 122 will be compressed between the annular seat 159 and the upper end 198 to form a water watertight seal between the upper housing 102 and the lower housing 104, such that water cannot escape between the upper housing 102 and the lower housing 104. Thus, any water entering the water inlet 112 will flow through the inflow insert with O-Ring press fit assembly 118 before flowing through the pressure regulator diaphragm pressure regulator with check valve flow tube assembly 114 where the spring 116 will operate to regulate the water pressure that is exiting the water outlet 110 of the upper housing 102.

The upper housing 102 includes a mount 103 on its exterior surface configured to pivotally couple to a latch or pivot latch 106. The mount 103 allows the pivot latch 106 to rotate about axis A2 in direction R4 (FIG. 5) from a locked position to an unlocked position. The mount 103 also allows the pivot latch 106 to rotate in direction R3 about axis A2 (FIG. 5) from an unlocked position to a locked position.

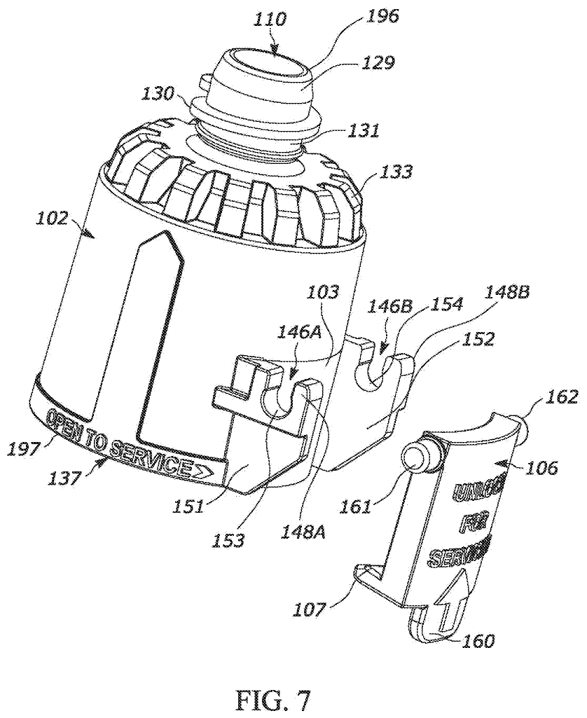

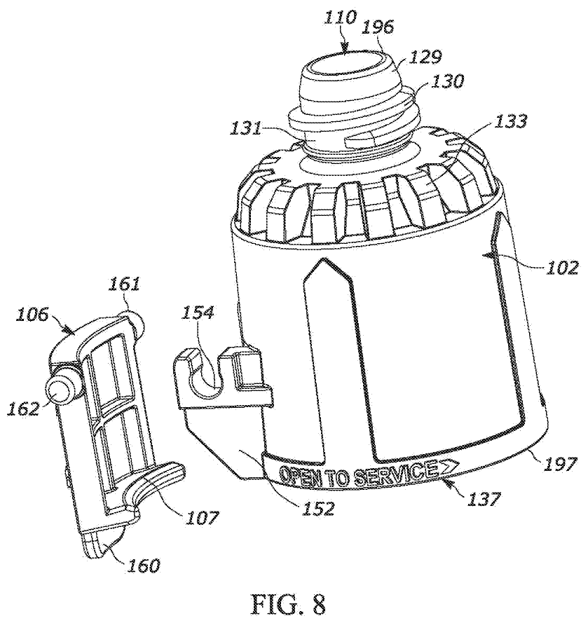

The mount 103 has a first arm 151 and a second arm 152 that extend from the exterior surface of the upper housing 102 (FIG. 6). The first arm 151 further includes a first cradle 153, and the second arm 153 includes a second cradle 154. The first cradle 153 receives a first pin 161 extending from a first side of the pivot latch body 160, and the second cradle 154 receives a second pin 162 extending from a second side of the pivot latch body 160 (FIGS. 7 and 8). When the first pin 161 and the second pin 162 are received within the cradles 153, 154 the pivot latch 106 can be rotated about axis A2 in directions R3 and R4 (FIG. 6) to move the pivot latch 106 between the locked and unlocked position.

Each of the cradles 153, 154 includes an opening 146A, 146B that is narrower than a diameter of the pins 161, 162. The openings 146A, 146B are formed in part from outer arms 148A, 148B that splay outward allowing each pin 161, 162 to be inserted into their respective cradles 153, 154. Once the pin 161, 162 has passed through the respective openings 146A, 146B, the respective outer arms 148A, 148B move back to their respective natural positions to secure the pin 161, 162 in their respective cradles 153, 154. This provides a snap fit attachment for the pivot latch 106 to the mount 103.

The lower housing 104 includes a locking channel assembly 105 that includes a first arm 140 and a second arm 141 and a channel or a locking channel 109 extending therebetween. The position of the mount 103 and the pivot latch 106 on the upper housing 102 and that of the locking channel assembly 105 on the lower housing 104 are determined so that when the upper housing 102 and the lower housing 104 are in the fully assembled state the mount 103, the pivot latch 106 will be directly aligned with the locking channel 109 of the locking channel assembly 105. Then, the pivot latch 106 can be rotated in direction R3 to be received into the locking channel 109 and the pivot latch 106 can be rotated in direction R4 to be released from the locking channel 109.

The pivot latch 106 includes an arcuate flange 107 that extends from the pivot latch 106 to engage an underside 125 of the locking channel 109 when the pivot latch 109 is in the locked position. The flange 107 may be angled slightly upward (FIG. 4) such that when the flange 107 engages with the underside 125 of the locking channel 109 an additional force is needed to make the flange 107 snap fit against the underside of the locking channel 109. The snap fit latching of the flange 107 with the underside 125 of the locking channel 109 will help prevent inadvertent unlatching of the pivot latch 106 into the unlocked position.

The female threads 132 of the upper housing 102 and the male threads 134 of the lower housing 104 are configured such that when the upper housing 102 and the lower housing 104 are turned tight, the mount 103 and the pivot latch 106 are aligned with the locking channel 109 on the lower housing 104 while still retaining the sealing function and support for the diaphragm 122. More specifically, the lower housing 104 also includes an annular collar 179 positioned to make contact with the lower end 197 of the upper housing 102 when the upper housing 102 and the lower housing 104 are in the fully closed position, such that the collar 179 acts as a stop to prevent the over rotation of the first housing 102 relative to the second housing 104 and ensures that the mount 102 and the pivot latch 106 are aligned with the locking channel 109. When in the locked state, the latch 106 is captured between the arms 151, 152, which prevents the upper and lower housings 102, 104 from rotating relative to one another.

Turning to FIG. 4, the diaphragm 122 also forms a watertight seal between the check valve 121 and the flow tube 124. These watertight seals force the water flowing from the water inlet 112 to flow through the openings 185 defined by the inlet adaptor 128 into the second end 178 of the flow tube 124 and out the first end 177 of the flow tube 124. From there, the water flows into a water pressure cavity 115 formed between the diaphragm 122 and the internal cavity 138 of the upper housing 102. As pressure increases in the water pressure cavity 115, the increased pressure on the diaphragm 122 moves the flow tube 124 in direction D2. Eventually, when the water pressure in the water pressure cavity 115 reaches a predetermined pressure, such as 30 psi, the amount of force on the diaphragm 122 will overcome the spring 116. This will cause the spring 116 to compress as the flow tube 124 moves in direction D2 to cause the watertight seal formed between the O-ring 120 on the check valve 121 and a sealing surface 157 on the upper housing 102 to break. This allows the pressurized water to flow out of the upper housing 102 via water outlet 110 and into a water receiving device, such as, but not limited to an irrigation hose or an irrigation sprinkler. As the pressure increases above the predetermined amount, the flow tube 124 moves in direction D2 to close the openings 185 in the inlet adapter 128 to maintain the flow pressure at or around the predetermined amount.

Likewise, if the water pressure decreases in the water pressure cavity 115 below the biasing force of the spring 116, the spring 116 will begin to extend, forcing the flow tube 124 to move in direction D1. This will cause the check valve 121 to close, forming the watertight seal formed between the O-ring 120 on the check valve 121 and a sealing surface 157 on the upper housing 102. As such, the water in the water pressure cavity 115 cannot exit the water outlet 110 and flow to the water receiving device until the water in the water pressure cavity 115 again reaches a sufficient psi to overcome the biasing force of the spring 116. Thus, the pressure regulator 100 also provides the benefit of preventing underpressurized water from flowing out of the water outlet 110 and eventually leaking from the irrigation system between irrigation cycles.

Further, as pressure increases beyond the predetermined pressure, the flow tube 124 will move further into the inflow insert 128 to regulate flow. More specifically, as the flow tube 124 moves into the inflow insert 128 it will reduce the size of the windows 185 of the inflow insert 128 to reduce the pressure of the flow leaving the pressure regulator 100. In like fashion, as the pressure drops towards the predetermined pressure, the spring 116 will move the flow tube 124 downstream, thereby opening the windows 185 to increase the pressure of the flow leaving the pressure regulator 100. The regulator ensures that the water flowing from the water outlet 110 of the upper housing 102 is optimally pressurized for the piece of irrigation equipment that the respective pressure regulator 100 using the pressure regulator system 114 is responsible for providing pressurized water to.

In addition to maintenance, the ability to easily open the pressure regulator 100 by de-coupling the upper housing 102 from the lower housing 104 allows a user to customize the internal components to meet a specific need. For example, if the regulator 100 is set to work with a first piece of irrigation equipment performing optimally at one psi, but the regulator is going to actually be used with a second piece of irrigation equipment that performs optimally at a different psi, the regulator can be easily opened to swap out select internal components, including the spring 116, and replace with the appropriate component(s), such as another spring to either increase or decrease the water pressure exiting the water outlet 112 of the pressure regulator 100. As such, when using a pressure regulator 100 as described herein, a user has the advantage of being able to open the regulator to replace components that meet the equipment's needs. This avoids the need of having to obtain a new or different pressure regulator.

Also, while the upper housing 102 is illustrated as having a male ACME fitting and the lower housing 104 is illustrated with a female NPT fitting, the fittings can be any generally known in the art, such as, but not limited to a male NPT fitting, a female NPT fitting, a male ACME fitting, or a female ACME fitting.

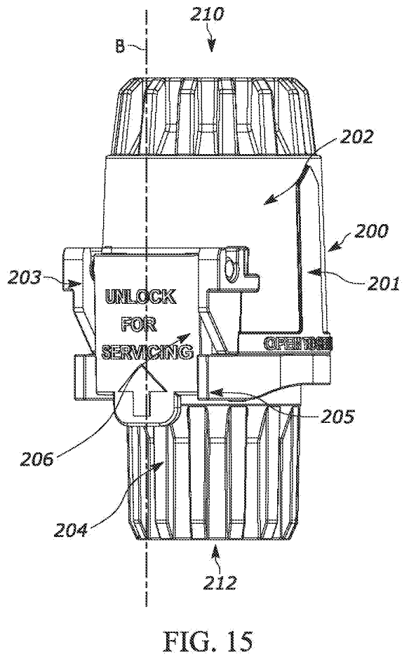

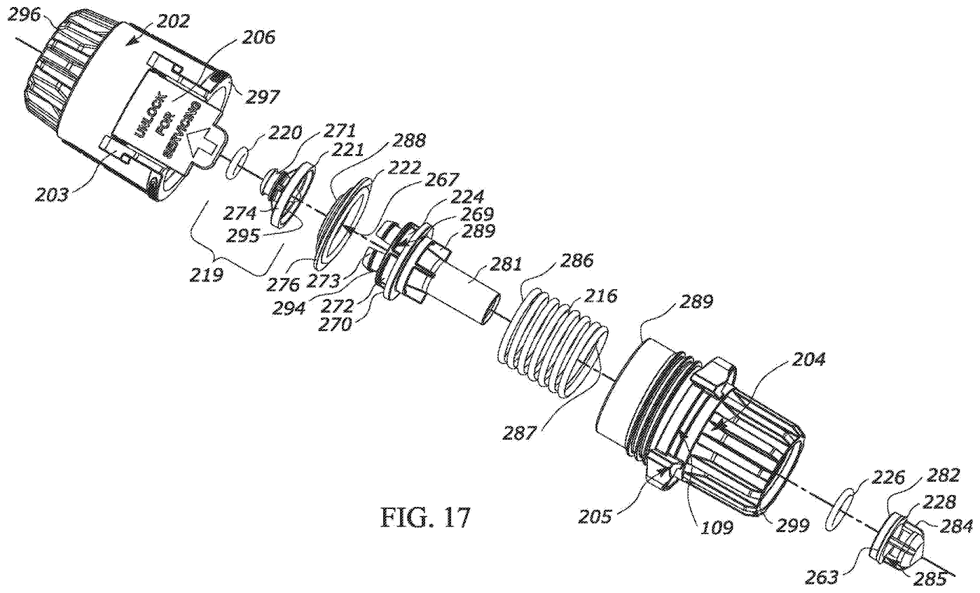

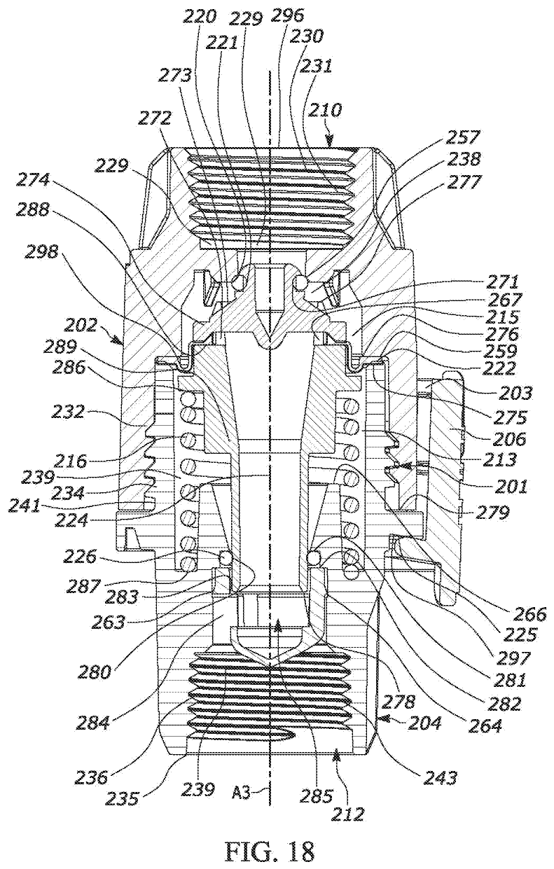

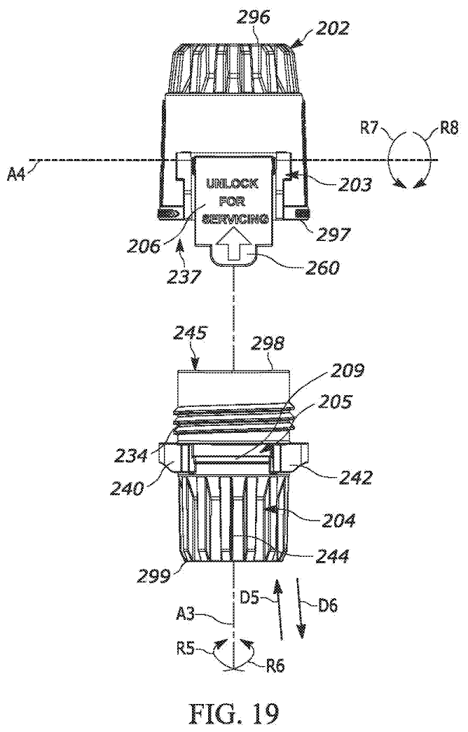

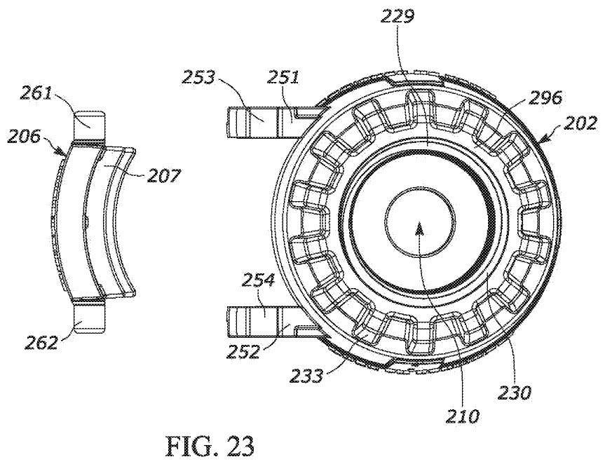

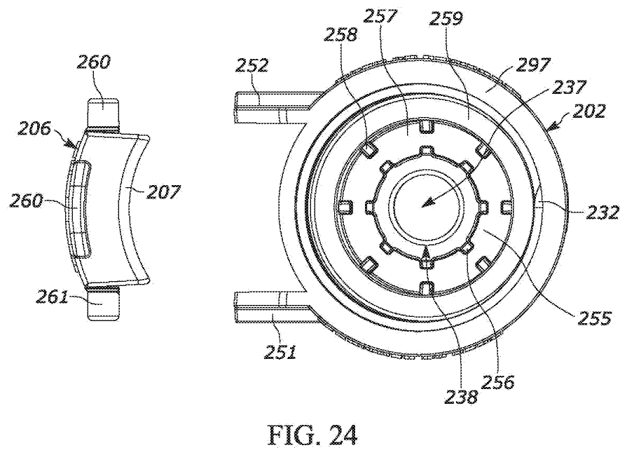

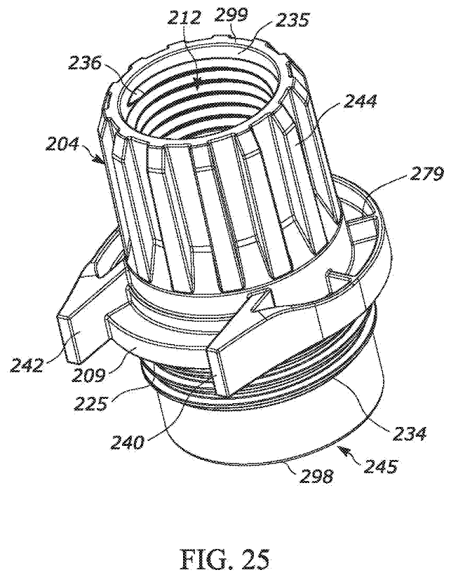

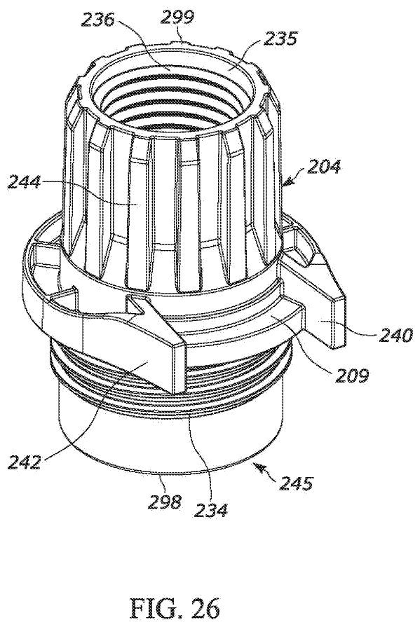

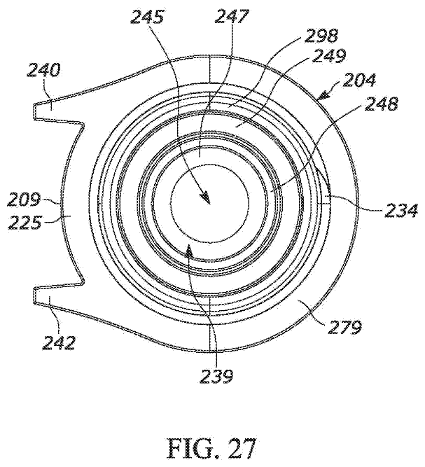

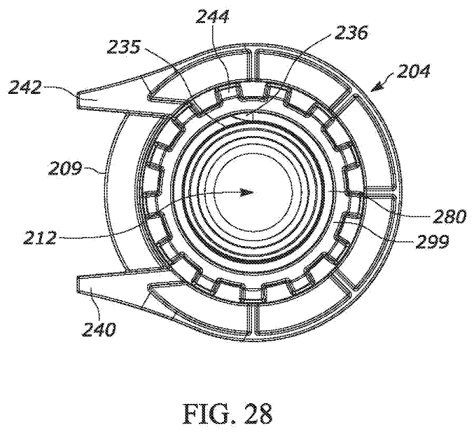

FIGS. 15-28 illustrate one embodiment of a pressure regulator with a serviceable lock 200 (hereinafter referred to as pressure regulator 200). The pressure regulator 200 includes a housing body 201 with a water outlet 210 and a water inlet 212 separated by an internal cavity 213 (FIG. 18). The housing body 201 has a first or upper or outflow housing 202 and a second or lower or inflow housing 204. The housings 202, 204 are separable from one another, such that the pressure regulator 200 has a first or open or disassembled position (FIG. 19) where the upper housing 202 is not coupled with the lower housing 204 and a second or closed or assembled position (FIG. 15) where the upper housing 202 is coupled to the lower housing 204.

The upper housing 202 includes a first or top end 296 and a second or bottom end 297 with an internal cavity 238 disposed therebetween. The top end 296 of the upper housing 202 includes the water outlet 210 disposed at a terminal end of a female coupling 229. An opposite end defines an opening 237 to the internal cavity 238 of the upper housing 202. The female coupling 229 includes a female thread 230 disposed about an internal surface 231 of the female coupling 229. The female coupling 229 configured to couple to a corresponding male coupling member with a corresponding male thread such as that on another component of an irrigation system. For example, it could be a corresponding male coupling on an irrigation hose. The female coupling 229 is rotationally coupled with the male coupling of the other component of an irrigation system by, for example, rotating the upper housing 202 in direction R6 about axis of rotation A3 until the female thread 230 forms a watertight seal with the male thread of the corresponding male coupling.

The lower housing 204 has a first or top end 298 and an opposite second or bottom end 299 with an internal cavity 239 formed therebetween. The top end 298 of the lower housing 204 defines an opening 245 into the internal cavity 239 of the lower housing 204. The bottom end 299 of the lower housing 204 includes the water inlet 212 proximate to a female coupling 235 that extends into the internal cavity 239 of the lower housing 204. The female coupling 235 removably couples to a water source (not shown), such as, but not limited to, male end of an irrigation hose. The female coupling 235 includes a female thread 236 disposed about an internal surface 243 of the female coupling 235. The female coupling 235 can be removably and rotationally coupled with the male coupling of the water providing source by rotating the lower housing 204 in direction R5 about axis of rotation A3 until a male thread of the male coupling engages with and forms a watertight seal with the female thread 236 of the female coupling 235.

The upper housing 202 includes a female thread 232 disposed about the internal cavity 238 at the opening 237, and the lower housing 204 includes a corresponding male thread 234 disposed about an exterior surface 241. The male thread 234 being configured to mate with the female thread 232 when an upper end 298 of the lower housing 204 is inserted into the opening 237 of the upper housing 202 so at least a portion of the upper end 298 of the lower housing 204 extends into the internal cavity 238 of the upper housing 202. The female thread 232 and the male thread 234 rotationally couple the lower end 297 of the upper housing 202 with the upper end 298 of the lower housing 204, such that a watertight seal is formed between the upper housing 202 and the lower housing 204.

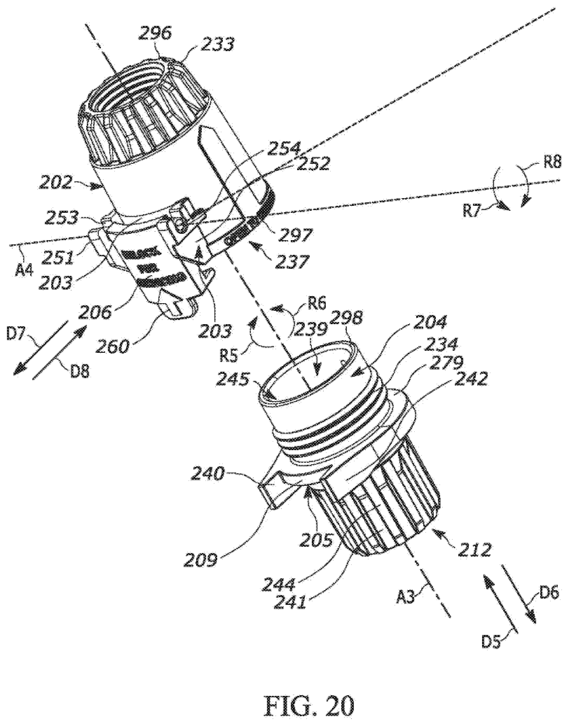

The upper housing 202 includes radially extending ridges 233 (FIG. 20) disposed about its exterior surface that enhance gripping for a user rotating the upper housing 202 about axis A3. Likewise, the lower housing 204 also includes radially extending ridges 244 (FIG. 20) disposed about its exterior surface to enhance gripping for a user when rotating the upper housing 204 about axis A3.

The upper housing 202 further includes a mount 203 on its exterior surface configured to pivotally couple to a latch or pivot latch 206. The mount 203 allows the pivot latch 206 to rotate about axis A4 in direction R8 (FIG. 20) from a locked position to an unlocked position. The mount 203 also allows the pivot latch 206 to rotate in direction R7 about axis A4 (FIG. 20) from an unlocked position to a locked position.

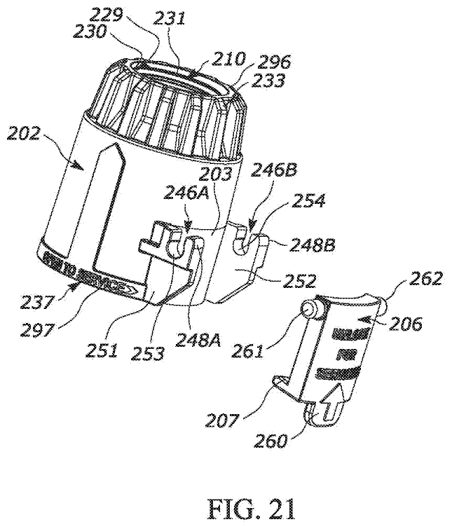

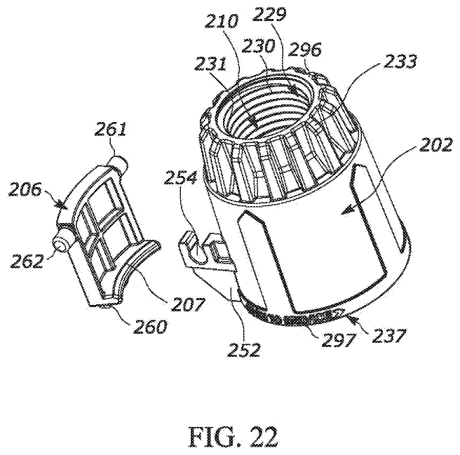

The mount 203 has a first arm 251 and a second arm 252 that extends from the exterior surface of the upper housing 202 (FIG. 20). The first arm 251 further includes a first cradle 253, and the second arm 253 includes a second cradle 254. The first cradle 253 receives a first pin 261 extending from a first side of the pivot latch body 260, and the second cradle 254 receives a second pin 262 extending from a second side of the pivot latch body 260 (FIGS. 21 and 22). When the first pin 261 and the second pin 262 are received within the cradles 253, 254 the pivot latch 206 can be rotated about axis A4 in directions R7 and R8 (FIG. 19) to move the pivot latch 206 between the locked and unlocked position.

Each of the cradles 253, 254 includes an opening 246A, 246B that is narrower than a diameter of the pins 261, 262. The openings 246A, 246B are formed in part from outer arms 248A, 248B that splay outward allowing each pin 261, 262 to be inserted into their respective cradles 253, 254. Once the pins 261, 262 have passed through the respective openings 246A, 246B, the respective outer arms 248A, 248B move back to their respective natural positions to secure the pins 261, 262 in their respective cradles 253, 254. This provides a snap fit attachment for the pivot latch 206 to the mount 203.

The lower housing 204 includes a locking channel assembly 205 that includes a first arm 240 and a second arm 241 and a channel or a locking channel 209 extending therebetween. The position of the mount 203 and the pivot latch 206 on the upper housing 202 and that of the locking channel assembly 205 on the lower housing 204 are determined so that when the upper housing 202 and the lower housing 204 are in the fully assembled state the mount 203 and the pivot latch 206 will be directly aligned with the locking channel 209 of the locking channel assembly 205. Then, the pivot latch 206 can be rotated in direction R7 to be received into the locking channel 209 and the pivot latch 206 can be rotated in direction R8 to be released from the locking channel 209.

The pivot latch 206 includes a flange 207 that extends from the pivot latch 206 to engage an underside 225 of the locking channel 209 when the pivot latch 209 is in the locked position. The flange 207 may be angled slightly upward (FIG. 18) such that when the flange 207 engages with the underside 225 of the locking channel 209 an additional force is needed to make the locking shelf 207 snap fit against the underside of the locking channel 209. The snap fit latching of the flange 207 with the underside 225 of the locking channel 209 will help prevent inadvertent unlatching of the pivot latch 206 into the unlocked position.

The female threads 232 of the upper housing 202 and the male threads 234 of the lower housing 204 are configured such that when the upper housing 202 and the lower housing 204 are turned tight, the mount 203 and the pivot latch 206 are aligned with the locking channel 209 on the lower housing 204 while still retaining the sealing function and support for the diaphragm 222. More specifically, the lower housing 204 also includes an annular collar 279 positioned to make contact with the lower end 297 of the upper housing 202 when the upper housing 202 and the lower housing 204 are in the fully closed position, such that the collar 279 acts as a stop to prevent the over rotation of the first housing 202 relative to the second housing 204 and ensures that the mount 202 and the pivot latch 206 are aligned with the locking channel 209. When in the locked state, the latch 206 is captured between the arms 251, 252, which prevents the upper and lower housings 202, 204 from rotating relative to one another.

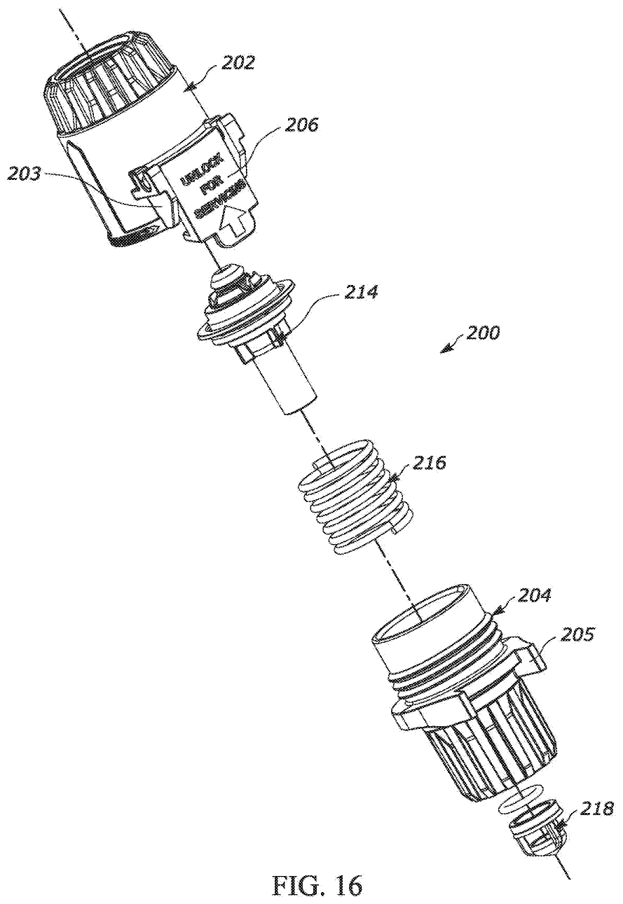

With reference to FIGS. 16-18, the interworking components of the pressure regulator 200 including the diaphragm pressure regulator with check valve flow tube assembly 214, the spring 216, and the inflow insert with O-ring press fit assembly 218 are the same as those discussed above relative to the pressure regulator 100. Further, all the interworking components of the pressure regulator 200 function the same and are installed the same as discussed in detail relative to the pressure regulator 100. In addition, all the interworking components of the pressure regulator 200 provide the pressure regulator 200 with all the same advantages as those discussed above relative to pressure regulator 100. Therefore, for the sake of efficiency the applicant has not repeated the function, installation, and advantages of the interworking components of the pressure regulator 200 but has included reference numbers showing similar parts of the interworking components of the pressure regulator 100 except showing the similar parts of the pressure regulator 200 in the “200” series of reference numerals.

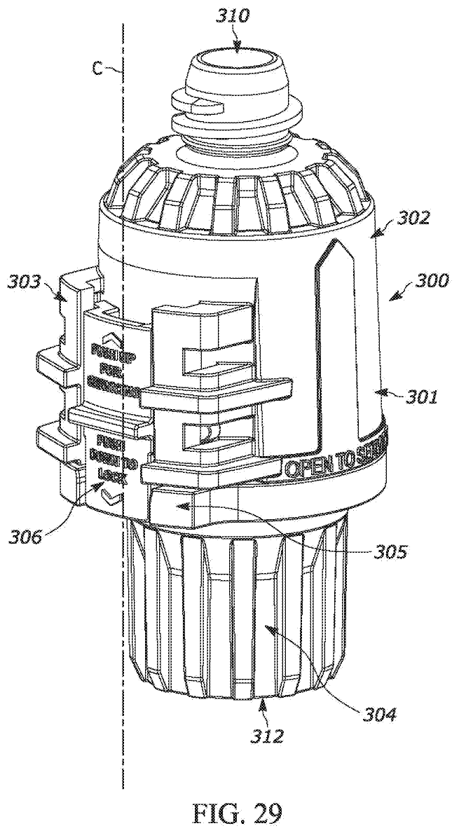

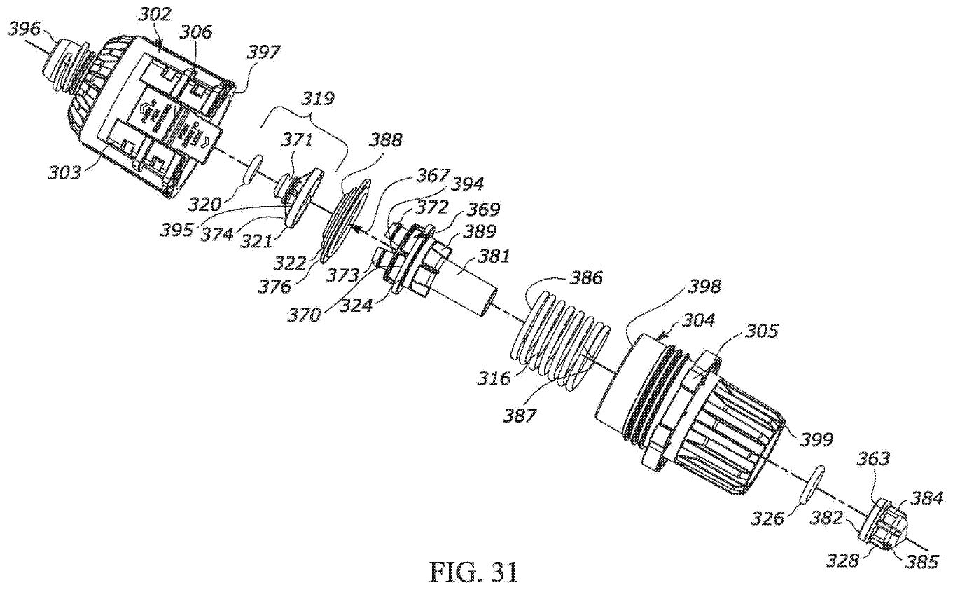

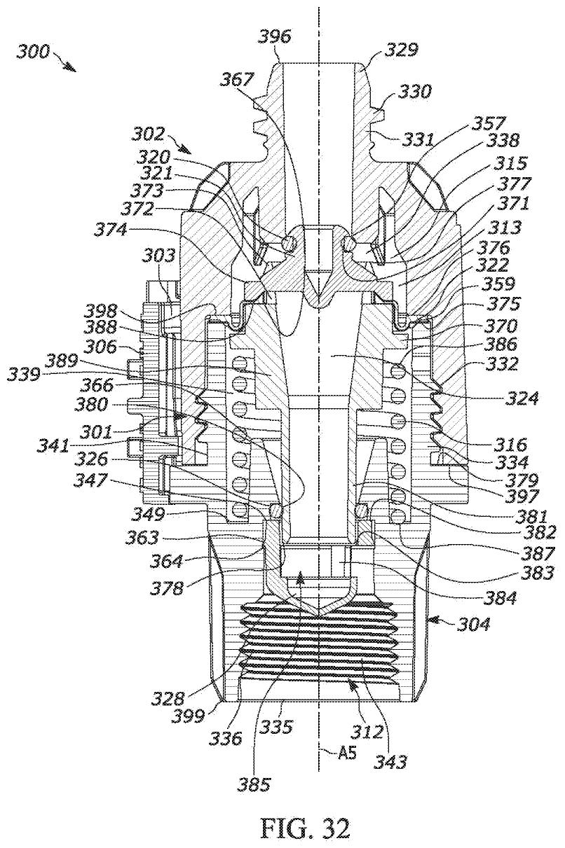

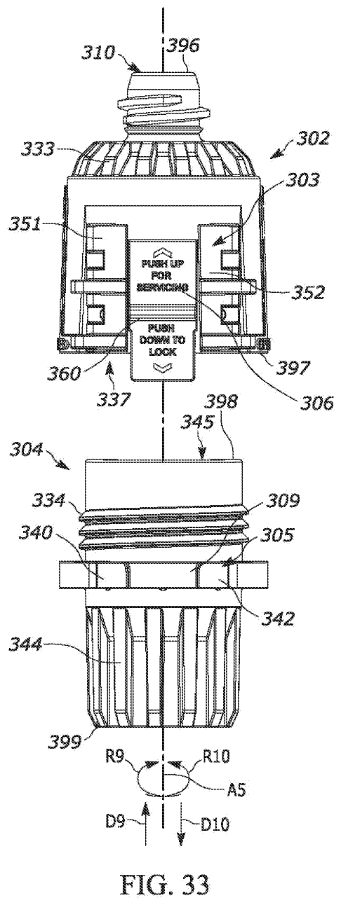

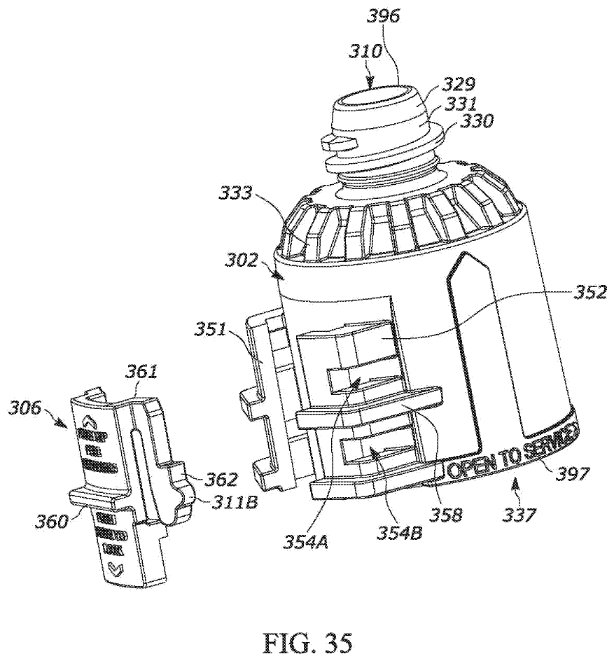

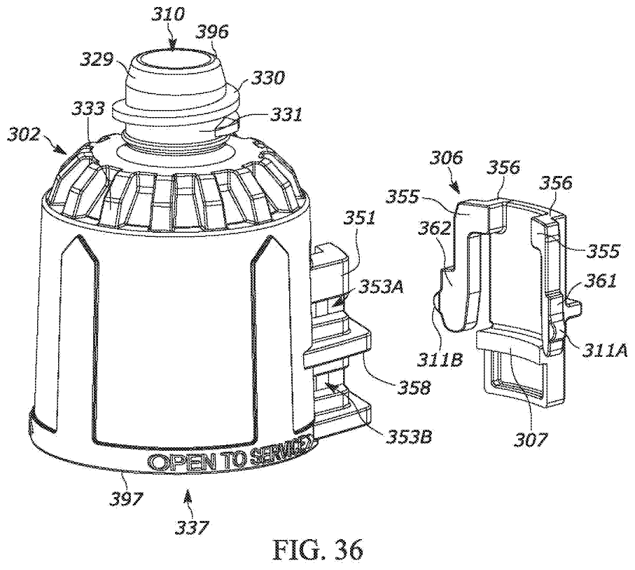

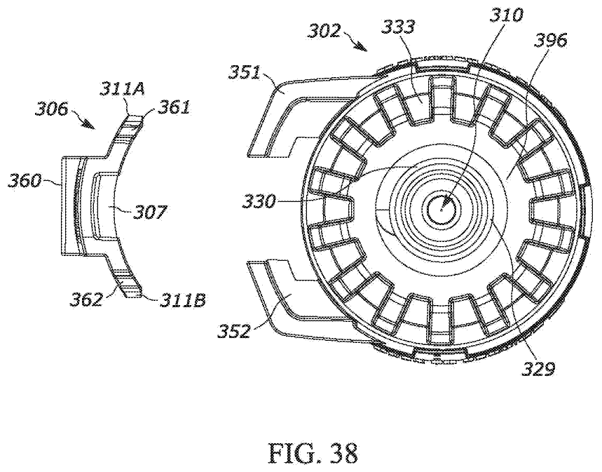

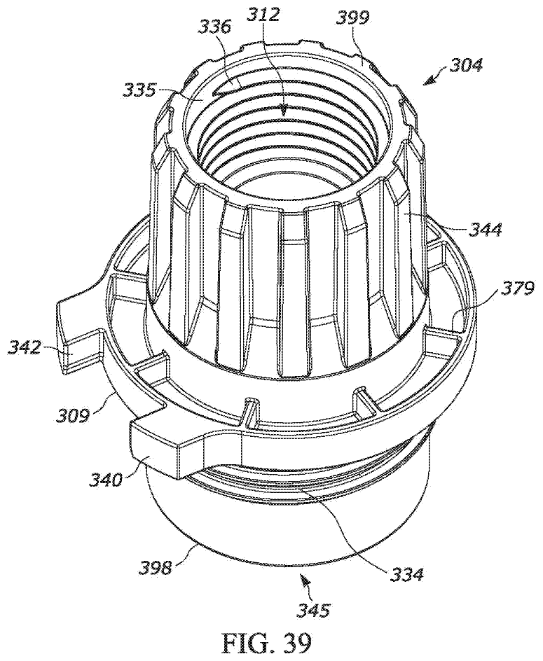

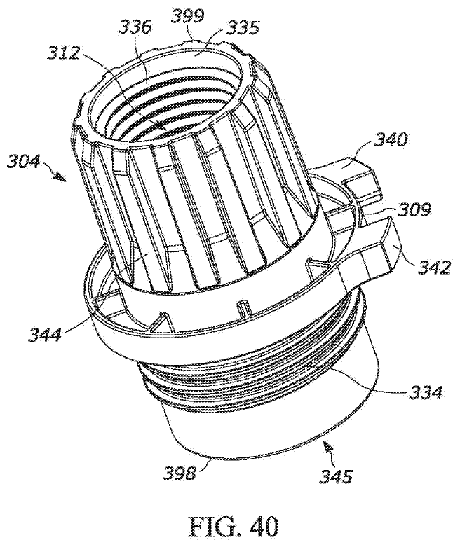

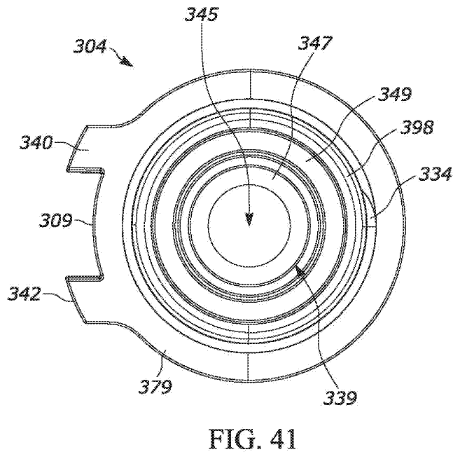

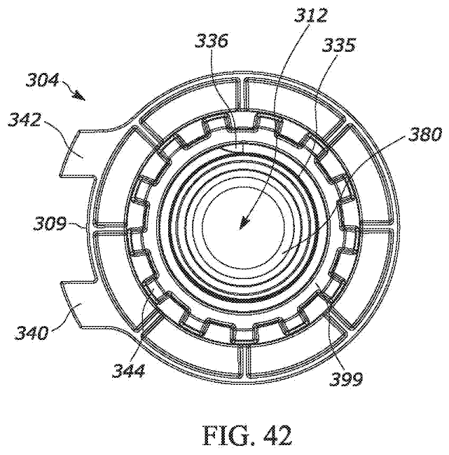

FIGS. 29-42 illustrate one embodiment of a pressure regulator with a serviceable lock 300 (hereinafter referred to as pressure regulator 300) according to one aspect of the present disclosure. The pressure regulator 300 has a housing body 301 with a water outlet 310 and a water inlet 312 with an internal cavity 313 (FIG. 32) disposed therebetween. The housing body 301 has a first or upper or outflow housing 302 and a second or lower or inflow housing 304 that are removably couplable together. The pressure regulator 300 has a first or open or disassembled position (FIG. 33) where the upper housing 302 is decoupled from the lower housing 304 and a second or closed or assembled position (FIG. 29) where the upper housing 302 is coupled with the lower housing 304.

The upper housing 302 has a first or top end 396 and an opposite second or bottom end 397 with an internal cavity 338 disposed therebetween. The top end 396 includes the water outlet 310 located at a terminal end of a male coupling 329 that extends from the upper housing 302. The bottom end includes an opening 337 into an internal cavity 338 of the upper housing 302.

The male coupling 329 includes a male thread 330 disposed about an exterior surface 331 of the male coupling 329. The male coupling 329 engages a corresponding female coupling with a corresponding female thread on a piece of irrigation equipment (not shown), such as, but not limited to, a corresponding female coupling on an irrigation hose. The male coupling 329 can be removably and rotationally coupled with the female coupling. More specifically, the upper housing 302 is rotated in direction R10 about axis of rotation A5 until the male thread 330 of the male coupling 329 engages with and forms a watertight seal with the female thread of the corresponding female coupling of the piece of irrigation equipment.

The lower housing 304 has a first or top end 398 and an opposite second or bottom end 399 with an internal cavity 339 formed therebetween. The top end 398 includes an opening 345 into an internal cavity 335, and the lower end 399 includes the water inlet 312 proximate to a female coupling 335 that extends into the internal cavity 339 of the lower housing 304. The female coupling 335 removably couples to a water providing source (not shown), such as, but not limited to, the male end of an irrigation hose connected to a water source. The female coupling 335 includes a female thread 336 disposed about an exterior surface 343 of the female coupling 335. The female thread 336 rotationally and removably couples to the water source (not shown), such as, but not limited to the male end of an irrigation hose. The female coupling 335 is removably and rotationally coupled to the male coupling of the water providing source by rotating the lower housing 304 in direction R10 about axis of rotation A5 until the male thread of the male coupling engages with and forms a watertight seal with the female thread 336 of the female coupling 335.

The upper housing 302 includes a female thread 332 disposed about an internal surface 331 defining a portion of the internal cavity 338, and the lower housing 304 including a corresponding male thread 334 disposed about an exterior surface 331 of the lower housing 304. The male thread 334 configured to engage the female thread 332 when the upper end 398 of the lower housing 304 is inserted into the opening 337 at the lower end 397 of the upper housing 302 so that at least a part of the upper end 398 of the lower housing 304 enters the internal cavity 338 of the upper housing 302. The female threads 332 and the male threads 334 engage one another to form a watertight seal is between the upper housing 302 and the lower housing 304. The upper and lower housings 302, 304 house the pressure regulator assembly, including the diaphragm pressure regulator with check valve flow tube assembly 314, spring 316, and inflow insert with O-ring press fit assembly 318.

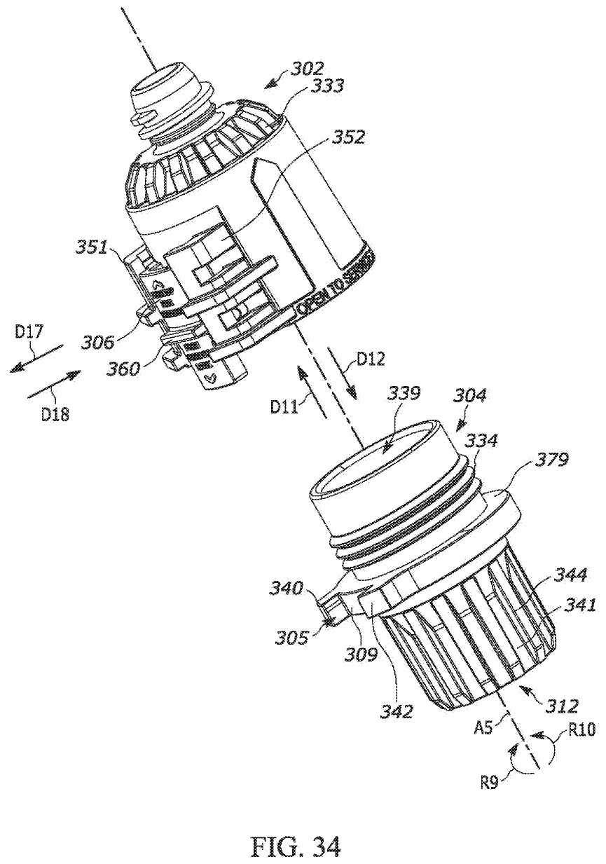

The upper housing 302 includes ridges 333 (FIG. 34) disposed about its exterior surface to enhance gripping for a user to rotate the upper housing 302 about axis A5. Likewise, the lower housing 304 includes ridges 344 (FIG. 34) disposed about its exterior surface to enhance gripping for a user to rotating the lower housing 304 about axis A5.

The upper housing 302 further includes a mount 303 on its exterior surface to receive and slidably couple a latch or a slide latch 306. The mount 303 allows the slide latch 306 to slide in direction D11 (FIG. 34) to move from a locked position to an unlocked position. The mount 303 also allows the slide latch 306 to slide in direction D12 (FIG. 34) to move from an unlocked position to a locked position.

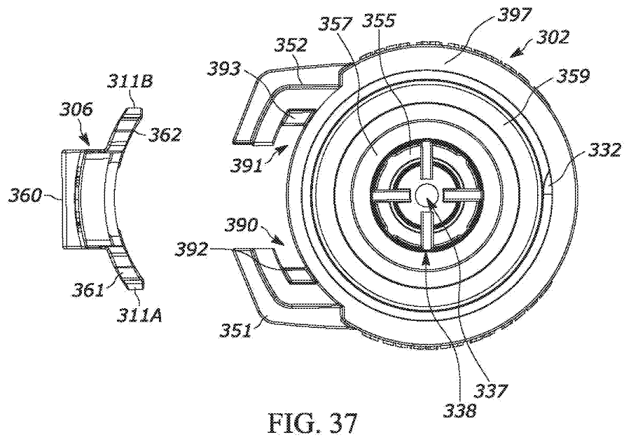

The mount 303 includes a first arm 351 and a second arm 352 that define a first rail 390 and a second rail 391 (FIG. 37), respectively. The slide latch 306 has a first prong 361 and a second prong 362 that extend from the slide latch 306 and are slidably coupled in the first rail 390 and the second rail 391, respectively, such that the first prong 361 and the second prong 362 can be slide in directions D11 and D12 (FIG. 34) relative to the upper housing 302 while remaining secured to the upper housing 302.

The first arm 351 further defines a first or upper opening 353A and a second or lower opening 353B through the first arm 351. The second arm 352 defines a first or upper opening 354A and a second or lower opening 354B through the second arm 352. The first prong 361 of the slide latch 306 includes a first detent 311A that engages with and locks the first prong 361 into the upper opening 353A and the lower opening 353B as the first prong 361 slides along the first rail 390. Likewise, the second prong 362 of the slide latch 306 includes a second detent 311B that engages with and locks the second prong 362 into the upper opening 354A and the lower opening 354B as the second prong 362 slides along the second rail 391. Each detent 311A, 311B extends from a moveable arm 355 that can move inward as the detents 311A, 311B cam over the arms 351, 352 to move from the first opening 353A, 354A to the second opening 353B, 354B and bias outward naturally to move the detents 311A, 311B into their respective openings 353A, 353B, 354A, 354B. Each arm extends from one end of the slide latch 306 towards a second opposite end. Each arm includes an attachment 356 extending from a backside 307 of the slide latch 306 and outward from the slide latch 306. This allows the arms to move inward behind the slide latch 306 as the detents 311A, 311B cam over the structure 358 of the arms 351, 352 between the upper (unlocked) openings 353A, 354A and the lower (locked) openings 354A, 354B.

The lower housing 304 includes a locking channel assembly 305 that includes a first arm 340 and a second arm 342 and a channel or a locking channel 309 extending therebetween. The position of the mount 303 and the slide latch 306 on the upper housing 302 and that of the locking channel assembly 305 on the lower housing 304 are determined so that when the upper housing 302 and the lower housing 304 are in the fully assembled state the mount 303 and the slide latch 306 will be directly aligned with the locking channel 309 of the locking channel assembly 305. Then, the slide latch 306 can be slide in direction D12 (FIG. 34) to be received into the locking channel 309 and the slide latch 306 can be slide in direction D11 to be released from the locking channel 309.

When the slide latch 306 is fully received into the locking channel 309 the first detent 311A and the second detent 311B will engage with the respective lower openings 354B,353B of the respective first arm 351 and second arm 352 of the mount 303 by at least partially extending into the respective lower openings 354B,353B. This will keep the slide latch 306 secured in place when it has been fully received into the locking channel 309. Further, the first arm 340 and the second arm 342 of the locking channel 309 will prevent the rotation of the upper housing 302 relative to the lower housing 304 by coming into contact with the slide latch 306 if either the upper housing 302 or lower housing 304 is rotated in direction R9 or R10 about axis A5 when the slide latch 306 has been fully received within the locking channel 309.

Further, the female threads 332 of the upper housing 302 and the male threads 334 of the lower housing 304 are configured such that when the upper housing 302 and the lower housing 304 are turned tight, the mount 303 and the slide latch 306 are aligned with the locking channel 309 on the lower housing 304 while still retaining the sealing function and support for the diaphragm 322. More specifically, the annular collar 379 of the lower housing 304 is positioned to make contact with the lower end 397 of the upper housing 302 when the upper housing 302 and the lower housing 304 are in the fully closed position, such that the annular collar 379 acts as a stop to prevent the over rotation of the first housing 302 relative to the second housing 304 and ensures that the mount 302 and the slide latch 306 are aligned with the locking channel 309.

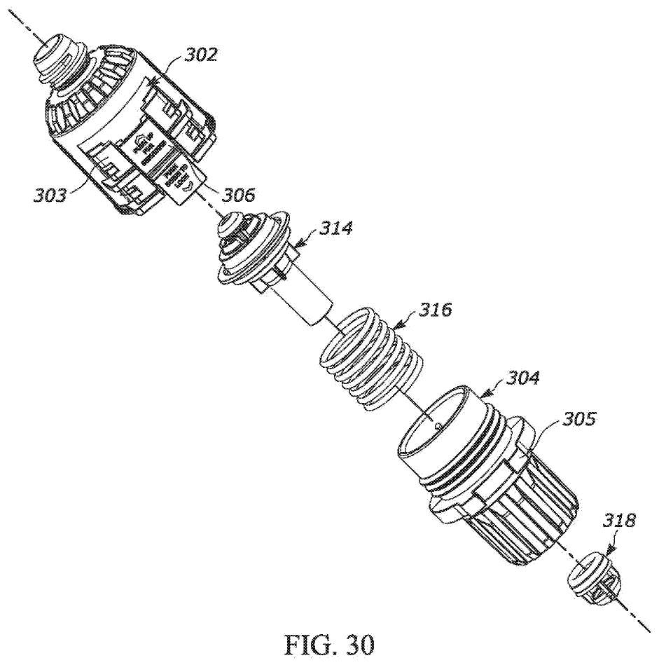

With reference to FIGS. 30-32, the interworking components of the pressure regulator 300 including the diaphragm pressure regulator with check valve flow tube assembly 314, the spring 316, and the inflow insert with O-ring press fit assembly 318 are the same as those discussed above relative to the pressure regulator 100. Further, all the interworking components of the pressure regulator 300 function the same and are installed the same as discussed in detail relative to the pressure regulator 100. In addition, all the interworking components of the pressure regulator 300 provide the pressure regulator 300 with all the same advantages as those discussed above relative to pressure regulator 100. Therefore, for the sake of efficiency the applicant has not repeated the function, installation, and advantages of the interworking components of the pressure regulator 300 but has included reference numbers showing similar parts of the interworking components of the pressure regulator 100 except showing the similar parts of the pressure regulator 300 in the “300” series of reference numerals.

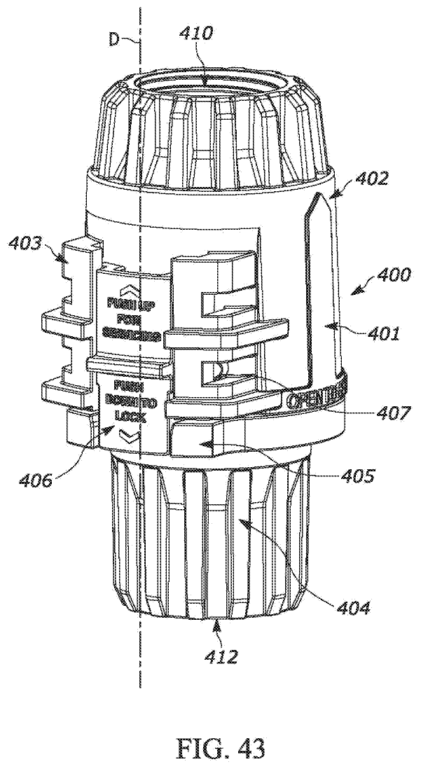

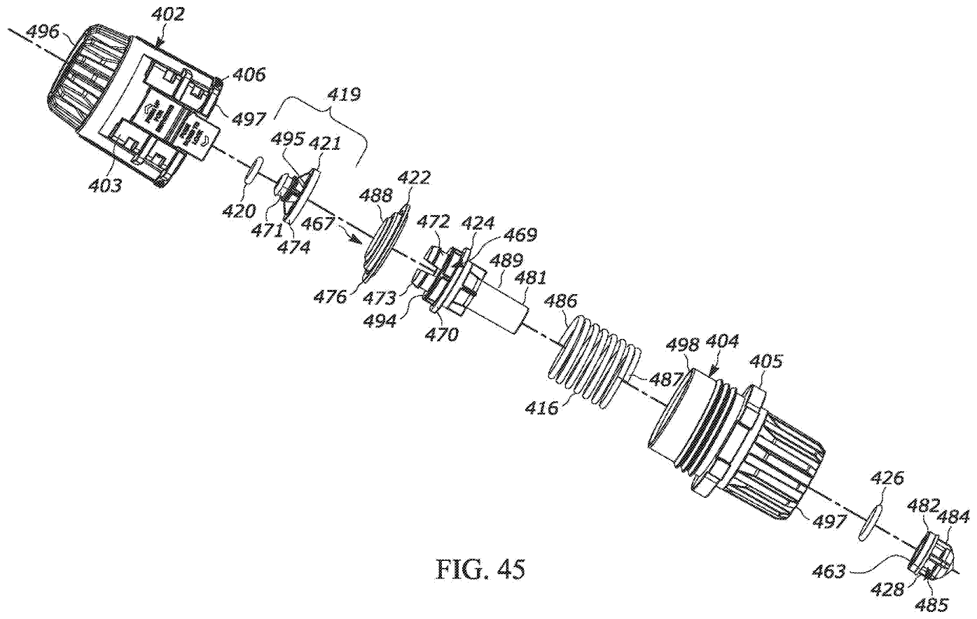

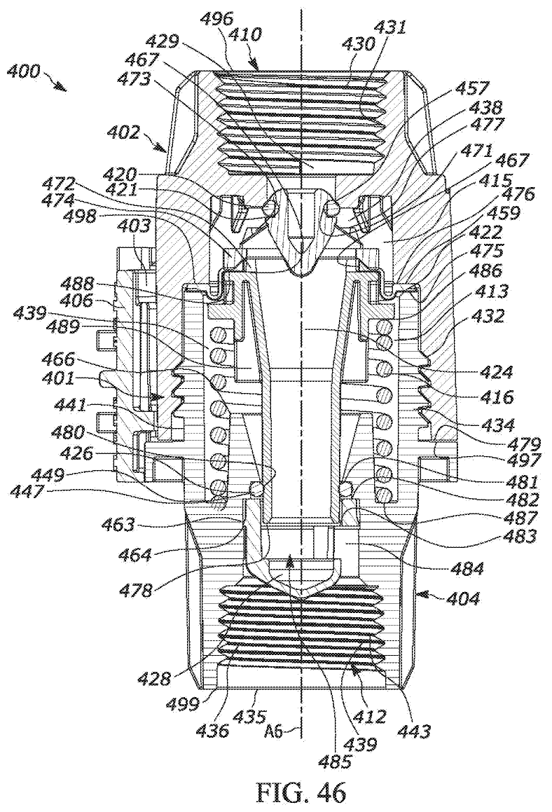

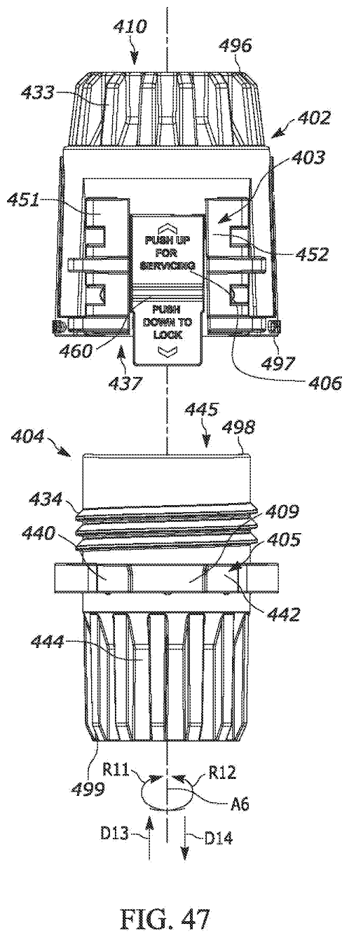

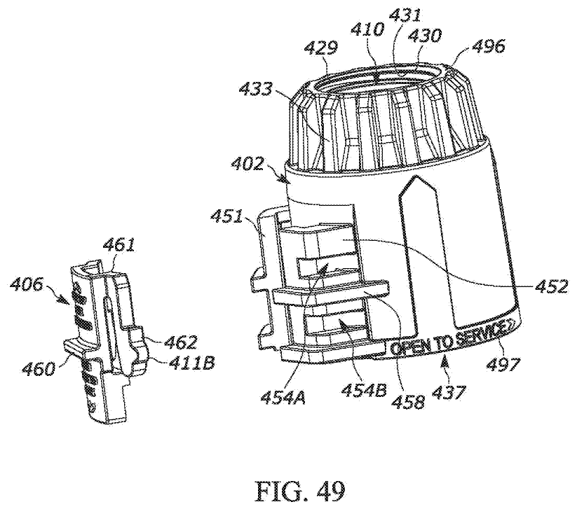

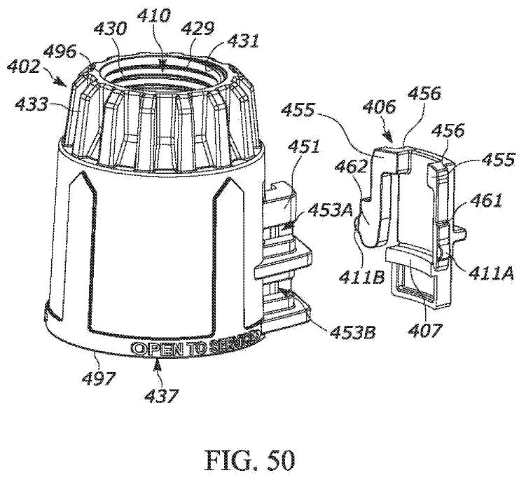

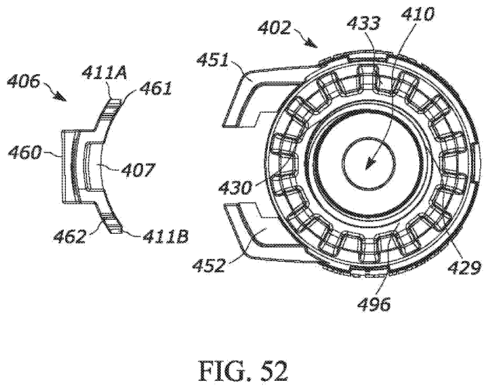

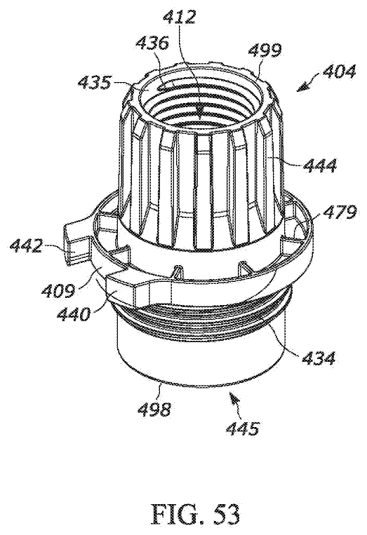

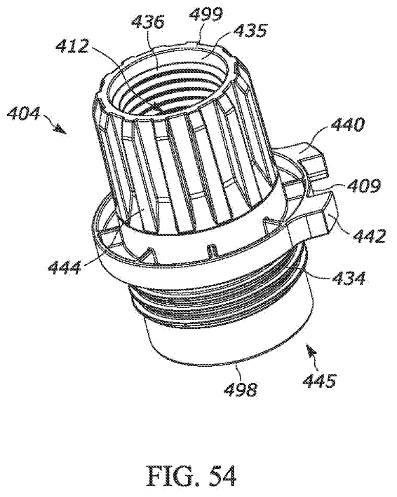

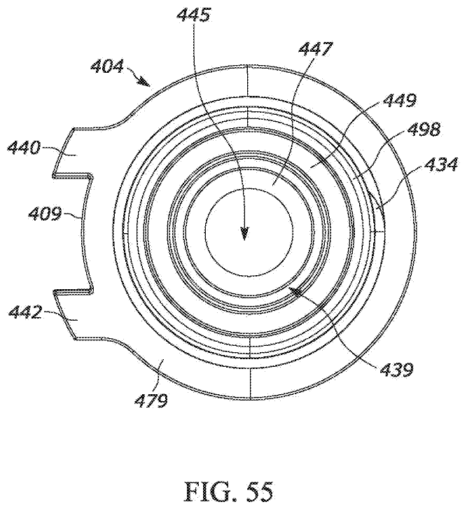

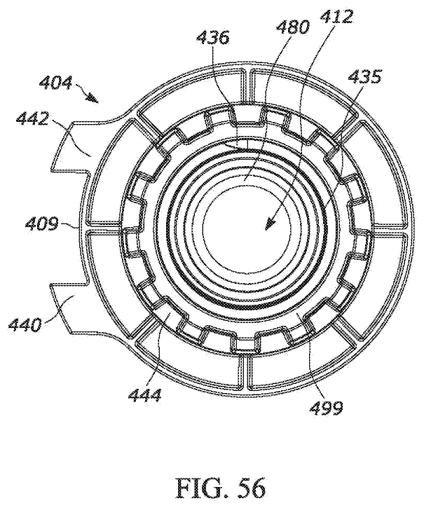

FIGS. 43-56 illustrate one embodiment of a pressure regulator with a serviceable lock 400 (hereinafter referred to as pressure regulator 400) according to one aspect of the present disclosure. The pressure regulator 400 has a housing body 401 with a water outlet 410 and a water inlet 412 with an internal cavity 413 (FIG. 46) disposed therebetween. The housing body 401 has a first or upper or outflow housing 402 and a second or lower or inflow housing 404 that are removably couplable together. The pressure regulator 400 has a first or open or disassembled position (FIG. 47) where the upper housing 402 is decoupled from the lower housing 404 and a second or closed or assembled position (FIG. 43) where the upper housing 402 is coupled with the lower housing 404.

The upper housing 402 has a first or top end 496 and an opposite second or bottom end 497 with an internal cavity 438 disposed therebetween. The top end 496 includes the water outlet 410 located at a terminal end of a female coupling member 429 that extends into the upper housing 402. The bottom end includes an opening 437 into an internal cavity 438 of the upper housing 402.

The female coupling member 429 includes a female thread 430 disposed about an internal surface 431 of the female coupling member 429. The female coupling member 429 engages a corresponding male coupling member with a corresponding male thread on a piece of irrigation equipment (not shown), such as, but not limited to, a corresponding male coupling member on an irrigation hose. The female coupling member 429 can be removably and rotationally coupled with the male coupling member. More specifically, the upper housing 402 is rotated in direction R12 about axis of rotation A6 until the female thread 430 of the female coupling member 429 engages with and forms a watertight seal with the male thread of the corresponding male coupling member of the piece of irrigation equipment.

The lower housing 404 has a first or top end 498 and an opposite second or bottom end 499 with an internal cavity 439 formed therebetween. The top end 498 includes an opening 445 into an internal cavity 439, and the lower end 499 includes the water inlet 412 proximate to a female coupling member 435 that extends into the internal cavity 439 of the lower housing 404. The female coupling member 435 removably couples to a water providing source (not shown), such as, but not limited to, the male end of an irrigation hose connected to a water source. The female coupling member 435 includes a female thread 436 disposed about an exterior surface 443 of the female coupling member 435. The female thread 436 rotationally and removably couples to the water source (not shown), such as, but not limited to the male end of an irrigation hose. The female coupling member 435 is removably and rotationally coupled to the male coupling member of the water providing source by rotating the lower housing 404 in direction R12 about axis of rotation A6 until the male thread of the male coupling member engages with and forms a watertight seal with the female thread 436 of the female coupling member 435.

The upper housing 402 includes a female thread 432 disposed about an internal surface 431 defining a portion of the internal cavity 438, and the lower housing 404 including a corresponding male thread 434 disposed about an exterior surface 431 of the lower housing 404. The male thread 434 configured to engage the female thread 432 when the upper end 498 of the lower housing 404 is inserted into the opening 437 at the lower end 497 of the upper housing 402 so that at least a part of the upper end 498 of the lower housing 404 enters the internal cavity 438 of the upper housing 402. The female threads 432 and the male threads 434 engage one another to form a watertight seal between the upper housing 402 and the lower housing 404. The upper and lower housings 402, 404 house the pressure regulator assembly, including the diaphragm pressure regulator with check valve flow tube assembly 414, spring 416, and inflow insert with O-ring press fit assembly 418.

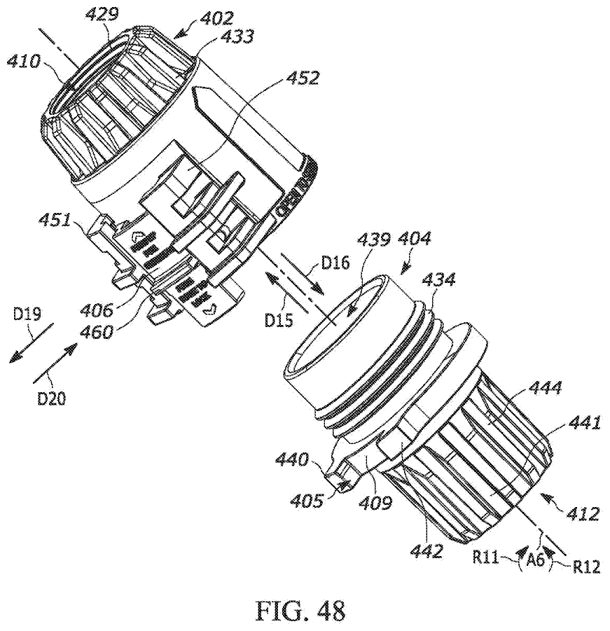

The upper housing 402 includes ridges 433 (FIG. 48) disposed about its exterior surface to enhance gripping for a user to rotate the upper housing 402 about axis A6. Likewise, the lower housing 404 includes ridges 444 (FIG. 48) disposed about its exterior surface to enhance gripping for a user to rotating the lower housing 404 about axis A6.

The upper housing 402 further includes a mount 403 on its exterior surface to receive and slidably couple a latch or a slide latch 406. The mount 403 allows the slide latch 406 to slide in direction D15 (FIG. 48) to move from a locked position to an unlocked position. The mount 403 also allows the slide latch 406 to slide in direction D16 (FIG. 48) to move from an unlocked position to a locked position.

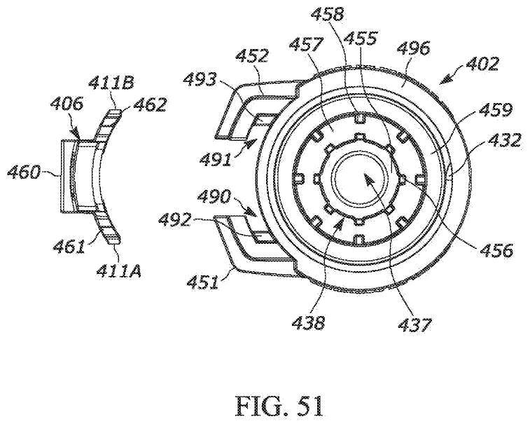

The mount 403 includes a first arm 451 and a second arm 452 that define a first rail 490 and a second rail 491 (FIG. 51), respectively. The slide latch 406 has a first prong 461 and a second prong 462 that extend from the slide latch 406 and are slidably coupled in the first rail 490 and the second rail 491, respectively, such that the first prong 461 and the second prong 462 can be slid in directions D15 and D16 relative to the upper housing 402 while remaining secured to the upper housing 402.

The first arm 451 further defines a first or upper opening 453A and a second or lower opening 453B through the first arm 451. The second arm 452 defines a first or upper opening 454A and a second or lower opening 454B through the second arm 452. The first prong 461 of the slide latch 406 includes a first detent 411A that engages with and locks the first prong 461 into the upper opening 453A and the lower opening 453B as the first prong 461 slides along the first rail 490. Likewise, the second prong 462 of the slide latch 406 includes a second detent 411B that engages with and locks the second prong 462 into the upper opening 454A and the lower opening 454B as the second prong 462 slides along the second rail 490. Each detent 411A, 411B extends from a moveable arm 455 that can move inward as the detents 411A, 411B cam over the arms 451, 452 to move from the first opening 453A, 454A to the second opening 453B, 454B and bias outward naturally to move the detents 411A, 411B into their respective openings 453A, 453B, 454A, 454B. Each arm extends from one end of the slide latch 406 towards a second opposite end. Each arm includes an attachment 456 extending from a backside 407 of the slide latch 406 and outward from the slide latch 406. This allows the arms to move inward behind the slide latch 406 as the detents 411A, 411B cam over the structure 458 of the arms 451, 452 between the upper (unlocked) openings 453A, 454A and the lower (locked) openings 454A, 454B.

The lower housing 404 includes a locking channel assembly 405 that includes a first arm 440 and a second arm 441 and a channel or a locking channel 409 extending therebetween. The position of the mount 403 and the slide latch 406 on the upper housing 402 and that of the locking channel assembly 405 on the lower housing 404 are determined so that when the upper housing 402 and the lower housing 404 are in the fully assembled state the mount 403 and the slide latch 406 will be directly aligned with the locking channel 409 of the locking channel assembly 405. Then, the slide latch 406 can be slide in direction D16 (FIG. 48) to be received into the locking channel 409 and the slide latch 406 can be slide in direction D15 to be released from the locking channel 409.

When the slide latch 406 is fully received into the locking channel 409 the first detent 411A and the second detent 411B will engage with the respective lower openings 454B,453B of the respective first arm 451 and second arm 452 of the mount 403 by at least partially extending into the respective lower openings 454B,453B. This will keep the slide latch 406 secured in place when it has been fully received into the locking channel 409. Further, the first arm 440 and the second arm 442 of the locking channel 409 will prevent the rotation of the upper housing 402 relative to the lower housing 404 by coming into contact with the slide latch 406 if either the upper housing 402 or lower housing 404 is rotated in direction R11 or R12 when the slide latch 406 has been fully received within the locking channel 409.

Further, the female threads 432 of the upper housing 402 and the male threads 434 of the lower housing 404 are configured such that when the upper housing 402 and the lower housing 404 are turned tight, the mount 403 and the slide latch 406 are aligned with the locking channel 409 on the lower housing 404 while still retaining the sealing function and support for the diaphragm 422. More specifically, the annular collar 279 of the lower housing 404 is positioned to make contact with the lower end 497 of the upper housing 402 when the upper housing 402 and the lower housing 404 are in the fully closed position, such that the collar 479 acts as a stop to prevent the over rotation of the first housing 402 relative to the second housing 404 and ensures that the mount 402 and the slide latch 406 are aligned with the locking channel 409.

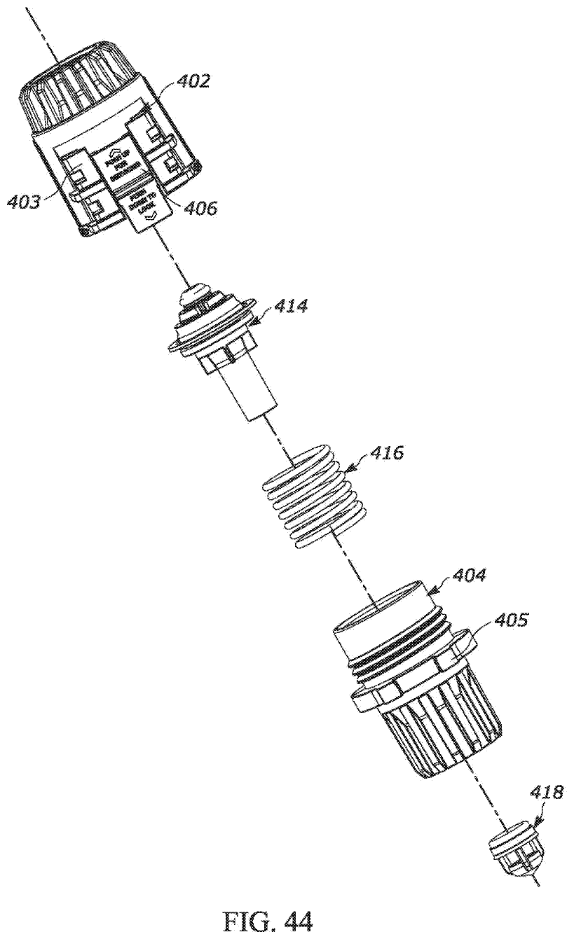

With reference to FIGS. 44-46, the interworking components of the pressure regulator 400 including the diaphragm pressure regulator with check valve flow tube assembly 414, the spring 416, and the inflow insert with O-ring press fit assembly 418 are the same as those discussed above relative to the pressure regulator 100. Further, all the interworking components of the pressure regulator 400 function the same and are installed the same as discussed in detail relative to the pressure regulator 100. In addition, all the interworking components of the pressure regulator 400 provide the pressure regulator 400 with all the same advantages as those discussed above relative to pressure regulator 100. Therefore, for the sake of efficiency the applicant has not repeated the function, installation, and advantages of the interworking components of the pressure regulator 400 but has included reference numbers showing similar parts of the interworking components of the pressure regulator 100 except showing the similar parts of the pressure regulator 400 in the “400” series of reference numerals.

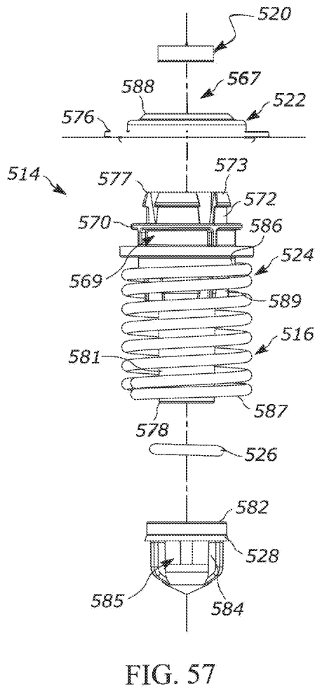

FIG. 57 is an exploded view of one embodiment of a pressure regulator assembly 514 according to one aspect of the present disclosure. The pressure regulator assembly 514 may be used with any of the embodiments of the pressure regulators with serviceable locks 100, 200, 300, 400 along with any other pressure regulator with a serviceable lock governed by the principles discussed herein. For the sake of efficiency, the applicant has not repeated the function, installation, and advantages of all the interworking components of the pressure regulator 514 but has included reference numbers showing similar parts of the interworking components of the pressure regulator 100 except showing the similar parts of the pressure regulator 514 in the “500” series of reference numerals.

The pressure regulator assembly 514 includes a retainer 520 (such as a snap retainer), a diaphragm 522, a flow tube 524, an O-ring 526, and an inflow insert 528. The diaphragm 522 is received on the flow tube 524, and the retainer 520 is received over the flanges 573 provided on the prongs 572 on the flow tube 524 where the retainer 520 will be seated against and form a watertight seal with the flow tube 524.

The inflow insert 528 is press fit on the end of the flow tube 524 opposite the diaphragm 522 and rubber washer 520. The O-ring 526 forms a watertight seal between the flow tube 524, the inflow insert 528, and the lower housing 104, 204, 304, 404 of the pressure regulator 100, 200, 300, 400. A spring 516 is also configured to rest against a surface of the flow tube 424 and a surface of the lower housing 104, 204, 304, 404, of the pressure regulator 100, 200, 300, 400, such that the spring 516 may be compressed when the water pressure in the water pressure cavity 115, 215, 315, 415 in the upper housing 102, 202, 302, 402 reaches a predetermined pressure based on the compressing strength of the spring 516.

When the water pressure in the water pressure cavity 115, 215, 315, 415 exceeds a predetermined pressure to overcome the biasing force of the spring 516, the spring 516 will compress thereby allowing the flow tube 524 to move upstream. As pressure increases beyond the predetermined pressure, the flow tube will move further into the insert 528 to regulate flow. More specifically, as the flow tube moves into the insert it will reduce the size of the windows 585 of the insert to reduce the pressure of the flow leaving the regulator. In like fashion, as the pressure drops towards the predetermined pressure, the spring will move the flow tube down-stream, thereby opening the windows 585 to increase the pressure of the flow leaving the regulator. The regulator ensures that the water flowing from the respective water outlet 110, 210, 310, 410 of the respective upper housing 102, 202, 302, 402 is optimally pressurized for the piece of irrigation equipment that the respective pressure regulator 100, 200, 300, 400 using the pressure regulator system 514 is responsible for providing pressurized water to.

The use of the terms “a” and “an” and “the” and similar referents used in the present application (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of any and all examples, or exemplary language (e.g., “such as”) provided herein, is intended merely to better illuminate what is being disclosed by the present application and does not pose a limitation on the scope of the disclosure in the present application unless otherwise claimed. No language in the specification should be construed as indicating any non-claimed element as essential to the practice of what is disclosed by the present application.

Preferred embodiments disclosed in the present application are described herein, including the best mode known by the applicant for carrying out what is disclosed in the present application. Variations of those preferred embodiments may become apparent to those of ordinary skill in the art upon reading the foregoing description. The applicant expects skilled artisans to employ such variations as appropriate, and the applicant intends for the disclosure in the present application to be practiced otherwise than as specifically described herein.

Accordingly, the disclosure of this application includes all modifications and equivalents of the subject matter recited in the claims appended hereto as permitted by applicable law. Moreover, any combination of the above-described elements in all possible variations thereof is encompassed by the disclosure of the present application unless otherwise indicated herein or otherwise clearly contradicted by context.

What is claimed is:

1. A pressure regulator with a serviceable lock comprising:
a first housing rotatably connected to a second housing;
a pressure regulator disposed in the first housing and/or the second housing;
one of the first housing and the second housing having a latch, and the other of the first housing and second housing having a channel; and
the latch moveable between a locked position where the latch is disposed in the channel to prohibit rotation of the first housing relative to the second housing and an unlocked position where the latch is disposed outside the channel to allow rotation of the first housing relative to the second housing to separate the first housing from the second housing.

2. The pressure regulator with a serviceable lock of claim 1, wherein the latch is pivotally coupled to one of the first housing and the second housing.

3. The pressure regulator with a serviceable lock of claim 2, wherein the latch includes a pivot arm capable of moving in a first direction and a second direction.

4. The pressure regulator with a serviceable lock of claim 2, wherein the latch includes a flange that engages one of the first housing and the second housing to prevent movement of the latch in the locked position.

5. The pressure regulator with a serviceable lock of claim 1, wherein the latch is slidably coupled to one of the first housing and the second housing.

6. The pressure regulator with a serviceable lock of claim 1, wherein the latch is coupled to a mount having a first arm and a second arm.

7. The pressure regulator with a serviceable lock of claim 1, wherein the pressure regulator is removably insertable within an internal cavity defined by at least one of the first housing and the second housing.

8. The pressure regulator with a serviceable lock of claim 1, wherein the pressure regulator includes a diaphragm that forms a watertight seal between the first housing and the second housing when the first housing and the second housing are in the locked position.

9. The pressure regulator with a serviceable lock of claim 1, wherein the latch is removably coupled to a mount on one of the first housing and the second housing.

10. The pressure regulator with a serviceable lock of claim 9, wherein the mount further includes a first arm and a second arm.

11. The pressure regulator with a serviceable lock of claim 10, wherein the first arm has a first cradle and the second arm has a second cradle.

12. The pressure regulator with a serviceable lock of claim 11, wherein the latch includes a first pin rotationally coupled with the first cradle and a second pin rotationally coupled with the second cradle.

13. The pressure regulator with a serviceable lock of claim 1, wherein the latch further includes a biasing arm with a detent.

14. The pressure regulator with a serviceable lock of claim 13, wherein further comprising a first extension with a first opening and a second opening sized to receive the first detent.

15. The pressure regulator with a serviceable lock of claim 14 wherein the first extension defines a first slot and further comprising a second extension that defines a second slot, the latch slidable in the first slot and the second slot between the locked position and the unlocked position.

16. A method for servicing a pressure regulator comprising:
actuating a latch in a first direction to move the latch from a locked position to an unlocked position;
separating a first housing from a second housing;
removing at least one component of a pressure regulator from an internal cavity formed between the first housing and/or the second housing;
repairing, cleaning, or replacing the at least one component of the pressure regulator;
placing the at least the one component of the pressure regulator into the internal cavity formed between the first housing and/or the second housing;
removably coupling the first housing and the second housing; and
actuating the latch in a second direction to move the latch from the unlocked position to the locked position.

17. The method of claim 16, wherein separating the first housing from the second housing includes rotating one of the first housing and the second housing relative to the other of the first housing and second housing.

18. The method of claim 16, wherein one of the first housing and the second housing includes a mount.

19. The method of claim 18, wherein the other of the first housing and second housing includes a channel.

20. The method of claim 18, wherein the latch is rotationally coupled to the mount to selectively engage the other of the first housing and the second housing in the locked position.

21. The method of claim 18, wherein the latch is slidably coupled to the mount to selectively engage the other of the first hosing and the second housing in the locked position.

22. The method of claim 16, wherein the pressure regulator includes a sealing component and further comprising cleaning the sealing component.

23. The method of claim 16, wherein the pressure regulator includes a first spring and further comprising replacing the first spring with a second spring.
